(19) United States
(12) Patent Application Publication
(10) Pub. No.: US 2020/0280057 A1
(43) Pub. Date: Sep. 3, 2020

(54) SILICON-BASED FINE PARTICLE/SILICON-CONTAINING POLYMER COMPOSITE AND METHOD OF PRODUCING THE SAME, SiOC STRUCTURE AND METHOD OF PRODUCING THE SAME, NEGATIVE ELECTRODE COMPOSITION USING SiOC STRUCTURE, NEGATIVE ELECTRODE, AND LITHIUM ION SECONDARY BATTERY

(71) Applicants: JNC CORPORATION, Tokyo (JP); JNC PETROCHEMICAL CORPORATION, Tokyo (JP)

(72) Inventors: Hirotsuna YAMADA, Chiba (JP); Miwako NISHIMURA, Chiba (JP); Masakazu KONDO, Chiba (JP); Soichiro SATO, Chiba (JP)

(73) Assignees: JNC CORPORATION, Tokyo (JP); JNC PETROCHEMICAL CORPORATION, Tokyo (JP)

(21) Appl. No.: 16/802,593

(22) Filed: Feb. 27, 2020

(30) Foreign Application Priority Data
Mar. 1, 2019 (JP) 2019-038012

(51) Int. Cl. H01M 4/36; H01M 10/0525; H01M 4/48; H01M 4/38; H01M 4/60

(52) U.S. Cl. CPC H01M 4/366; H01M 10/0525; H01M 2004/027; H01M 4/386; H01M 4/602; H01M 4/483

(57) ABSTRACT

There are provided a material for a negative electrode active material exhibiting a favorable capacity retention rate and Coulomb efficiency, a method of producing the material, a negative electrode composition using the material, a negative electrode, and a secondary battery. A SiOC structure, includes (A) at least one silicon-based fine particles; and (B) a SiOC coating layer containing at least Si (silicon), O (oxygen), and C (carbon) as constituent elements, wherein the at least one silicon-based fine particles are covered with the SiOC coating layer, and the average particle size based on a volume-based particle size distribution is in a range of 1 nm to 999 μm.

### CROSS-REFERENCE TO RELATED APPLICATION

This application claims the priority benefit of Japan Application No. 2019-038012, filed on Mar. 1, 2019. The entirety of the above-mentioned patent application is hereby incorporated by reference herein and made a part of this specification.

### BACKGROUND

### Technical Field

The disclosure relates to a silicon-based fine particle/silicon-containing polymer composite and SiOC structure which have a predetermined form, a negative electrode composition using the same, a negative electrode, and a secondary battery.

### Description of Related Art

Secondary batteries are used as drive power sources in various electronic devices, communication devices, and eco cars such as hybrid vehicles. Regarding such secondary batteries, the development of various lithium ion batteries in which a lithium intercalation compound that releases lithium ions from an interlayer is used as a positive electrode material, and a carbonaceous material (for example, graphite) that can store and release lithium ions between layers of crystal planes during charging and discharging is used as a negative electrode material has mainly progressed and such batteries have been put into practice.

Under the background as described above, in recent years, along with miniaturization of various electronic devices and communication devices and rapid spreading of hybrid vehicles and the like, there has been a strong demand for the development of secondary batteries having a higher capacity and various further improved battery characteristics such as cycle characteristics and discharging rate characteristics as drive power sources of such devices and the like. In order to realize such a high-performance secondary batteries, research and development focusing on specifically negative electrode active materials has been continuously performed, and for example, the following techniques are known.

For example, Patent Document 1 discloses a SiOC composite material obtained by physically mixing various polysilsesquioxanes and silicon particles, and heating the resulting mixture under predetermined conditions, a negative electrode using the SiOC composite material as a negative electrode active material, and a lithium ion battery. In Patent Document 1, it was found that, when the negative electrode active material is used, it is possible to improve the battery capacity and cycle durability in the battery cycle test. Here, Patent Document 1 describes that, in the disclosed SiOC composite material, silicon particles are embedded in a SiOC matrix that is derived from a polysilsesquioxane. However, it is understood that “embedding” of silicon particles into the SiOC matrix refers to a structure realized by physical mixing of the polysilsesquioxane and silicon particles as described above, that is, a structure in which silicon particles are simply dispersed in a SiOC matrix.

In addition, Patent Document 2 discloses a negative electrode material composed of composite particles in which the entire surface or a part of inorganic particles that can store or release lithium ions is covered with a ceramic. More specifically, the negative electrode material disclosed in Patent Document 2 is a negative electrode material for a non-aqueous electrolyte secondary battery in which the inorganic particles include at least one selected from the group consisting of Si, Sn and Zn as constituent elements, and the ceramic is composed of an oxide, a nitride or a carbide containing at least one element selected from the group consisting of Si, Ti, Al and Zr. In Patent Document 2, it is suggested that, according to the negative electrode material having such a configuration, it is possible to reduce the change in the volume of the negative electrode material which can be caused by intercalation/deintercalation of lithium ions and the like, and it is possible to improve battery characteristics such as charging and discharging cycle characteristics. In Patent Document 2, regarding a specific form of the negative electrode material, some examples in which inorganic fine particles composed of Si and the like are coated with SiOC ceramics are described. However, in view of these examples, the negative electrode material disclosed in Patent Document 2 is produced through the following production step. That is, phenyltrimethoxysilane is made into a sol as precursor organic molecules, the inorganic fine particles are added to the resulting sol, and the mixture is additionally subjected to a hydrolysis reaction and a polycondensation reaction and gelled to form a bulk gel. The bulk gel that is converted into SiOC ceramics due to heating is used as a negative electrode material. Therefore, in the negative electrode material disclosed in Patent Document 2, it is thought that inorganic fine particles that are dispersed in SiOC ceramics derived from the bulk gel are retained.

In addition, Patent Document 3 discloses silicon composite particles obtained by sintering silicon, a silicon alloy, or silicon oxide fine particles together with an organosilicon compound or a mixture thereof, and a negative electrode material for a non-aqueous electrolyte secondary battery using the silicon composite particles. The silicon composite particles disclosed in Patent Document 3 have a structure in which a silicon inorganic compound formed by sintering of the organosilicon compound or a mixture thereof serves as a binder, silicon or silicon alloy fine particles are dispersed therein, and voids are present in the particles. Patent Document 3 discloses that, when such silicon composite particles are used as a negative electrode material, favorable cycle characteristics are obtained. Specifically, the silicon composite particles disclosed in Patent Document 3 are obtained by curing a mixture of silicon fine particles and a curable siloxane composition composed of various organosilicon compounds such as a siloxane compound and crushing a silicon composite obtained by heating the obtained mass. Therefore, also in the negative electrode material disclosed in Patent Document 3, it was found that fine particles of silicon and the like dispersed in the silicon composite are present.

In addition, Patent Document 4 discloses a negative electrode active material for a non-aqueous electrolyte secondary battery formed of a ceramic composite material in which metallic silicon and SiC are dispersed in SiOC ceramics. More specifically, in the ceramic composite material disclosed in Patent Document 4, in X-ray diffraction using CuKα characteristic X-rays, when the peak intensity of the (111) plane diffraction line of the metallic silicon is set as b1, and the peak intensity of the SiC (111) plane diffraction line is set as b2, a ratio represented by b1/b2 and the density when compression is performed at 30 MPa are in predetermined numeric ranges. Patent Document 4 suggests that, according to a secondary battery using a negative electrode active material made from such a ceramic composite material, an excellent initial efficiency, charging and discharging capacity, and cycle characteristics are exhibited. Specifically, the ceramic composite material disclosed in Patent Document 4 is produced through the following production step. That is, a polymer obtained by adding metallic silicon particles to a carbon precursor solution in which a novolac phenolic resin as a carbon source is dissolved, then adding tetraethoxysilane, and polymerizing the silane compound is heated and cured and subjected to a desolvation treatment step, and burned to obtain a ceramic composite material, which is used as a negative electrode active material. Therefore, also in the ceramic composite material disclosed in Patent Document 4, metallic silicon and SiC particles are dispersed in SiOC ceramics.

In addition, Patent Document 5 is a Chinese patent application and discloses a nano silicon energy storage material having a core-shell structure as shown in the drawings, and a lithium ion battery including the storage material. Specifically, the nano silicon energy storage material disclosed in Patent Document 5 is a composite material obtained by performing a surface treatment on Si nanoparticles using a silane coupling agent, uniformly dispersing the Si nanoparticles subjected to the surface treatment in hydrolyzates of various organic silane compounds, additionally polycondensing the hydrolyzates to obtain a polycondensate, and coating the polycondensate with a petroleum pitch and then burning it. According to the core-shell structure shown in the drawings, the composite material is considered to be composed of a silicon nanoparticle core, an intermediate layer that is derived from a polymerizable organosiloxane, and an outer shell that is derived from a petroleum pitch positioned outside the intermediate layer. However, in Patent Document 5, while the SEM image showing the appearance of the actually obtained composite material is shown (FIG. 5 in the document), no results of examining the internal structure are shown, and there are many unclear points about whether the core-shell structure shown in the schematic diagrams in FIG. 3 and FIG. 4 in the document is actually formed.

### PATENT DOCUMENTS

[Patent Document 1] Published Japanese Translation No. 2018-502029 of the PCT International Publication

[Patent Document 2] Japanese Patent Laid-Open No. 2004-335335

[Patent Document 3] Japanese Patent Laid-Open No. 2005-310759

[Patent Document 4] Japanese Patent Laid-Open No. 2017-62974

[Patent Document 5] Chinese Patent Laid-Open No. 107464926

As described above, along with miniaturization of various electronic devices and communication devices and rapid spreading of hybrid vehicles and the like, in secondary batteries used as drive power sources of such devices and the like, further improvement in various battery characteristics including various cycle characteristics such as a capacity retention rate and Coulomb efficiency is always required, and particularly, research and development focusing on negative electrode active materials has been actively performed.

Under such circumstances, the inventors also developed the negative electrode active material described in Patent Document 1 and various negative electrode active materials, and in particular, have conducted studies focusing on various production steps of the negative electrode active material using a SiOC composite material for mass production on an industrial scale. Particularly, the inventors are developing various SiOC composite materials obtained by burning a composite material of silicon nanoparticles and a polysilsesquioxane for use as a negative electrode active material. In the development of such a SiOC composite material, the inventors found that, when a functional silane compound as a starting material for polysilsesquioxane synthesis is hydrolyzed, and then polycondensed in the presence of a predetermined dispersant and silicon-based fine particles, a silicon nanoparticle/polysilsesquioxane composite in which silicon-based fine particles are uniformly coated on a polysilsesquioxane coating layer having a relatively smooth outer surface is produced, and a uniform coating structure of silicon nanoparticles with such a coating layer is maintained even if it is converted into a SiOC structure due to a heat treatment. In addition, the inventors found that, when a lithium ion secondary battery is produced using a SiOC structure having such a structure as a negative electrode active material, battery characteristics such as a cycle capacity retention rate and average Coulomb efficiency are improved. That is, the disclosure has been completed based on the above findings, and the disclosure provides a material for a negative electrode active material that can realize a favorable capacity retention rate and Coulomb efficiency, a method of producing the material, a negative electrode composition using the material as a negative electrode active material, a negative electrode and a secondary battery.

### SUMMARY

The disclosure provides the following.

[1] A SiOC structure, including:

(A) at least one silicon-based fine particles; and

(B) a SiOC coating layer containing at least Si (silicon), O (oxygen), and C (carbon) as constituent elements,
wherein the at least one silicon-based fine particles are covered with the SiOC coating layer, and
the average particle size based on a volume-based particle size distribution is in a range of 1 nm to 999 μm.

[2] The SiOC structure according to [1],
wherein the at least one silicon-based fine particles and the SiOC coating layer are chemically bonded to each other.

[3] The SiOC structure according to [1] or [2],
wherein the average particle size based on a volume-based particle size distribution is in a range of 1 nm to 100 μm.

[4] The SiOC structure according to any one of [1] to [3],
wherein the average particle size based on a volume-based particle size distribution is in a range of 500 nm to 20 μm.

[5] The SiOC structure according to any one of [1] to [4] wherein the average particle size based on a volume-based particle size distribution is in a range of 1 μm to 10 μm.

[6] The SiOC structure according to any one of [1] to [5],
wherein the at least one silicon-based fine particles are completely covered with the SiOC coating layer and thus a plurality of secondary particles are formed.

[7] The SiOC structure according to [6],
wherein a plurality of silicon-based fine particles are contained in at least one of the plurality of secondary particles.

[8] A negative electrode composition including the SiOC structure according to any one of [1] to [7] as a negative electrode active material.

[9] The negative electrode composition according to [8], further including a carbon-based conductive additive and/or a binder.

[10] A negative electrode including the negative electrode composition according to [8] or [9].

[11] A secondary battery including at least one of the negative electrode according to [10].

[12] The secondary battery according to [11], which is a lithium ion secondary battery.

[13] A silicon-based fine particle/silicon-containing polymer composite, including

(A) at least one silicon-based fine particles; and

(B) a coating layer containing a silicon-containing polymer,
wherein the at least one silicon-based fine particles are covered with the coating layer, and
the average particle size based on a volume-based particle size distribution is in a range of 1 nm to 999 μm.

[14] The silicon-based fine particle/silicon-containing polymer composite according to [13],
wherein the at least one silicon-based fine particles and the coating layer are chemically bonded to each other.

[15] The silicon-based fine particle/silicon-containing polymer composite according to [13] or [14],
wherein the silicon-containing polymer is a polysilsesquioxane.

[16] The silicon-based fine particle/silicon-containing polymer composite according to any one of [13] to [15], wherein the average particle size based on a volume-based particle size distribution is in a range of 1 nm to 100 μm.

[17] The silicon-based fine particle/silicon-containing polymer composite according to any one of [13] to [16], wherein the average particle size based on a volume-based particle size distribution is in a range of 10 nm to 60 μm.

[18] The silicon-based fine particle/silicon-containing polymer composite according to any one of [13] to [17], wherein the average particle size based on a volume-based particle size distribution is in a range of 100 nm to 1 μm.

[19] The silicon-based fine particle/silicon-containing polymer composite according to any one of [13] to [18], wherein the at least one silicon-based fine particles are completely covered with the coating layer and thus a plurality of secondary particles are formed.

[20] The silicon-based fine particle/silicon-containing polymer composite according to [19],
wherein a plurality of silicon-based fine particles are contained in at least one of the plurality of secondary particles.

[21] The silicon-based fine particle/silicon-containing polymer composite according to any one of [13] to [20],
wherein the silicon-containing polymer includes at least one selected from the group consisting of polysilsesquioxanes having polysilsesquioxane structures represented by the following General Formulae (I), (II), (III), and (IV):

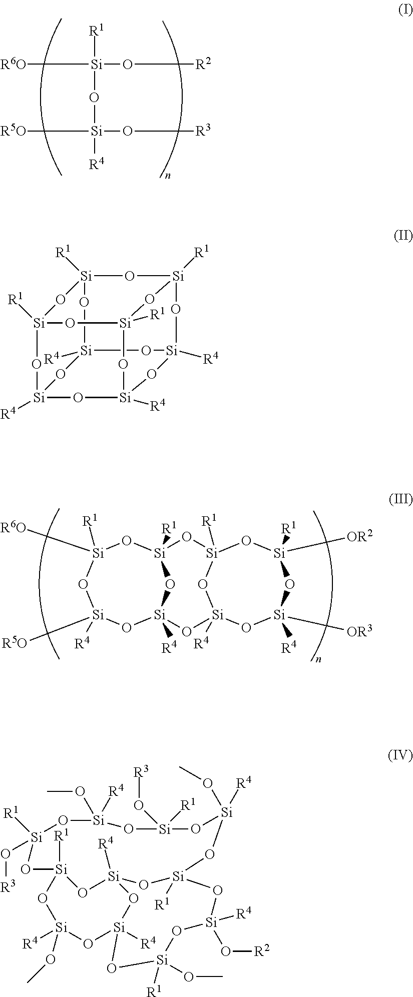

(in the formula, R¹ and R⁴ are each independently selected from the group consisting of a substituted or unsubstituted alkyl group having 1 to 45 carbon atoms, a substituted or unsubstituted aryl group, and a substituted or unsubstituted arylalkyl group, and in the alkyl group having 1 to 45 carbon atoms, any hydrogen atom is optionally substituted with a halogen atom, any —CH₂— is optionally substituted with —O—, —CH═CH—, a cycloalkylene group or a cycloalkenylene group, and in an alkylene group in the substituted or unsubstituted arylalkyl group, any hydrogen atom is optionally substituted with a halogen atom, and any —CH₂— is optionally substituted with —O—, —CH═CH— or a cycloalkylene group, and
R², R³, R⁵ and R⁶ are each independently selected from the group consisting of a hydrogen atom, a substituted or unsubstituted alkyl group having 1 to 45 carbon atoms, a substituted or unsubstituted aryl group, and a substituted or unsubstituted arylalkyl group, and in the alkyl group having 1 to 45 carbon atoms, any hydrogen atom is optionally substituted with a halogen atom, any —CH₂— is optionally substituted with —O—, —CH═CH—, a cycloalkylene group, a cycloalkenylene group or —SiR¹₂—, and in an alkylene group in the substituted or unsubstituted arylalkyl group, any hydrogen atom is optionally substituted with a halogen atom, any —CH₂— is optionally substituted with —O—, —CH═CH—, a cycloalkylene group, a cycloalkenylene group or —SiR¹₂—, and n represents an integer of 1 or more).

[22] A method of producing a silicon-based fine particle/silicon-containing polymer composite, including
hydrolyzing a silane compound represented by

(p) General Formula (V):

R¹ₙSiX¹₄₋ₙ (V)
(in the formula, R¹ represents a hydrogen atom, a hydroxyl group, or a substituted or unsubstituted hydrocarbon group having 1 to 45 carbon atoms, and in the hydrocarbon group having 1 to 45 carbon atoms, any hydrogen atom is optionally substituted with a halogen atom, and any —CH₂— is optionally substituted with —O—, —CH═CH—, a cycloalkylene group or a cycloalkenylene group,
X¹ represents a halogen atom or an alkyloxy having 1 to 6 carbon atoms or an acetoxy group,
when there are a plurality of R¹'s and X¹'s, they are independent from each other, and
n represents an integer of 0 to 3) and then performing polycondensation in the presence of a dispersant and silicon-based fine particles, and thereby producing the silicon-based fine particle/silicon-containing polymer composite according to any one of [13] to [21].

[23] The method according to [22],
wherein the silane compound represented by General Formula (V) is a silane compound represented by the following General Formula (VI):

R¹⁰Si(R⁷)(R⁸)(R⁹) (VI)

(in the formula, R⁷, R⁸ and R⁹ each independently represent a hydrogen atom, a halogen atom, a hydroxyl group or an alkyloxy group having 1 to 4 carbon atoms, R¹⁰ is selected from the group consisting of a substituted or unsubstituted alkyl group having 1 to 45 carbon atoms, a substituted or unsubstituted aryl group, and a substituted or unsubstituted arylalkyl group, and in the alkyl group having 1 to 45 carbon atoms, any hydrogen atom is optionally substituted with a halogen atom, any —CH₂— is optionally substituted with —O—, —CH═CH—, a cycloalkylene group or a cycloalkenylene group, and in an alkylene group in the substituted or unsubstituted arylalkyl group, any hydrogen atom is optionally substituted with a halogen atom, and any —CH₂— is optionally substituted with —O—, —CH═CH—, a cycloalkylene group or a cycloalkenylene group).

[24] The method according to [23],
wherein the dispersant is a nonionic surfactant.

[25] The method according to [23] or [24],
wherein the dispersant is polysorbates.

[26] The method according to any one of [23] to [25],
wherein the dispersant is polysorbate 80.

[27] The method according to any one of [23] to [26],
wherein, in Step (p), the proportion of the dispersant contained in the reaction solution when the silane compound is polycondensed is in a range of 1 part by mass to 200 parts by mass with respect to 100 parts by mass of the silane compound.

[28] The method according to any one of [23] to [26],
wherein, in Step (p), the proportion of the dispersant contained in the reaction solution when the silane compound is polycondensed is in a range of 1 part by mass to 150 parts by mass with respect to 100 parts by mass of the silane compound.

[29] The method according to any one of [23] to [28],
wherein, in Step (p), the reaction solution when the silane compound is polycondensed contains a solvent in an amount 20 to 200 times that of the silicon-based fine particles based on mass.

[30] The method according to any one of [23] to [29],
wherein, in Step (p), the reaction solution when the silane compound is polycondensed contains a solvent in an amount 30 to 150 times that of the silicon-based fine particles based on mass.

[31] The method according to any one of [23] to [30],
wherein, in Step (p), the reaction solution when the silane compound is polycondensed contains 0.1 parts by mass to 70 parts by mass of silicon-based fine particles with respect to 100 parts by mass of the silane compound.

[32] The method according to any one of [23] to [31], further including
before Step (p),
(p′) providing a silicon-based fine particle dispersion solution containing the silicon-based fine particles, the dispersant, an acid catalyst, and a solvent,
wherein, in Step (p),
(p-1) the silane compound is added to the silicon-based fine particle dispersion solution and the silane compound is hydrolyzed, and
(p-2) a basic catalyst or a solution thereof is added to the reaction solution obtained in Step (p-1), a hydrolyzate of the silane compound is polycondensed, and thereby the silicon-based fine particle/silicon-containing polymer composite is produced.

[33] The method according to any one of [23] to [32],
wherein, in the reaction solution during hydrolysis of the silane compound, the proportion of the acid catalyst is 0.02 parts by mass to 15 parts by mass with respect to 100 parts by mass of the silane compound, and in the reaction solution during polycondensation of the hydrolyzate of the silane compound, the proportion of the basic catalyst is 0.02 parts by mass to 15 parts by mass with respect to 100 parts by mass of the silane compound.

[34] The method according to [32] or [33],
wherein, in Step (p-1), the silane compound is added to the silicon-based fine particle dispersion solution by dropwise addition, and the silane compound is hydrolyzed, and
in Step (p-2), a basic catalyst solution is added to the reaction solution obtained in Step (p-1) by dropwise addition, a hydrolyzate of the silane compound is polycondensed, and thereby the silicon-based fine particle/silicon-containing polymer composite is produced.

[35] The method according to any one of [32] to [34],
wherein the acid catalyst is acetic acid or hydrochloric acid.

[36] The method according to any one of [32] to [35],
wherein the basic catalyst is ammonia water.

[37] The method according to any one of [32] to [36],
wherein, in Step (p-1), under conditions in which the pH of the reaction solution is in a range of 2.0 to 6.0, the silane compound is hydrolyzed, and
in Step (p-2), a basic catalyst or a solution thereof is gradually added to the reaction solution obtained in Step (p-1), and thus the pH of the reaction solution is raised to a value in a range of 7.0 to 13.5, and a hydrolyzate of the silane compound is polycondensed.

[38] The method according to any one of [23] to [37], further including
(q′) filtering and/or drying the silicon-based fine particle/silicon-containing polymer composite obtained in Step (p).

[39] The method according to any one of [23] to [38],
wherein the silane compound is at least one silane compound selected from the group consisting of methyltrimethoxysilane and phenyltrimethoxysilane.

[40] A method of producing a SiOC structure, including
(q) performing a heat treatment on the silicon-based fine particle/silicon-containing polymer composite according to any one of [13] to [21] under a non-oxidizing gas atmosphere and thus converting the composite into the SiOC structure according to any one of [1] to [7].

[41] The method according to [40],
wherein the non-oxidizing gas atmosphere in Step (q) is an atmosphere containing an inert gas.

[42] The method according to [40] or [41],
wherein the non-oxidizing gas atmosphere in Step (q) is an atmosphere containing nitrogen gas and/or argon gas.

[43] The method according to any one of [40] to [42],
wherein, in Step (q), the silicon-based fine particle/silicon-containing polymer composite is heated at a temperature in a range of 400° C. to 1,800° C. and heating is performed at the temperature for a time in a range of 30 minutes to 10 hours.

[44] The method according to any one of [40] to [43], further including
before Step (q), the following Step (p) in which a silane compound represented by General Formula (V) is hydrolyzed and polycondensed in the presence of a dispersant and silicon-based fine particles, and thus the silicon-based fine particle/silicon-containing polymer composite according to any one of [13] to [21] is produced:

(p) General Formula (V):

R¹ₙSiX¹₄₋ₙ (V)
(in the formula, R¹ represents a hydrogen atom, a hydroxyl group, or a substituted or unsubstituted hydrocarbon group having 1 to 45 carbon atoms, and in the hydrocarbon group having 1 to 45 carbon atoms, any hydrogen atom is optionally substituted with a halogen atom, and any —CH₂— is optionally substituted with —O—, —CH═CH—, a cycloalkylene group or a cycloalkenylene group,
X¹ represents a halogen atom or an alkyloxy having 1 to 6 carbon atoms or an acetoxy group,
when there are a plurality of R¹'s and X¹'s, they are independent from each other, and
n represents an integer of 0 to 3).

[45] The method according to [44],
wherein the silane compound represented by General Formula (V) is a silane compound represented by the following General Formula (VI):

R¹⁰Si(R⁷)(R⁸)(R⁹) (VI)

in the formula, R⁷, R⁸ and R⁹ each independently represent a hydrogen atom, a halogen atom, a hydroxyl group or an alkyloxy group having 1 to 4 carbon atoms, R¹⁰ is selected from the group consisting of a substituted or unsubstituted alkyl group having 1 to 45 carbon atoms, a substituted or unsubstituted aryl group, and a substituted or unsubstituted arylalkyl group, and in the alkyl group having 1 to 45 carbon atoms, any hydrogen atom is optionally substituted with a halogen atom, any —CH₂— is optionally substituted with —O—, —CH═CH—, a cycloalkylene group or a cycloalkenylene group, and in an alkylene group in the substituted or unsubstituted arylalkyl group, any hydrogen atom is optionally substituted with a halogen atom, and any —CH₂— is optionally substituted with —O—, —CH═CH—, a cycloalkylene group or a cycloalkenylene group).

[46] The method according to [44] or [45],
wherein the dispersant is a nonionic surfactant.

[47] The method according to any one of [44] to [46],
wherein the dispersant is polysorbates.

[48] The method according to any one of [44] to [47],
wherein the dispersant is polysorbate 80.

[49] The method according to any one of [44] to [48],
wherein, in Step (p), the proportion of the dispersant contained in the reaction solution when the silane compound is polycondensed is in a range of 1 part by mass to 200 parts by mass with respect to 100 parts by mass of the silane compound.

[50] The method according to any one of [44] to [49],
wherein, in Step (p), the proportion of the dispersant contained in the reaction solution when the silane compound is polycondensed is in a range of 1 part by mass to 150 parts by mass with respect to 100 parts by mass of the silane compound.

[51] The method according to any one of [44] to [50],
wherein, in Step (p), the reaction solution when the silane compound is polycondensed contains a solvent in an amount 20 to 200 times that of the silicon-based fine particles based on mass.

[52] The method according to any one of [44] to [51],
wherein, in Step (p), the reaction solution when the silane compound is polycondensed contains a solvent in an amount 30 to 150 times that of the silicon-based fine particles based on mass.

[53] The method according to any one of [44] to [52],
wherein, in Step (p), the reaction solution when the silane compound is polycondensed contains 0.1 parts by mass to 70 parts by mass of silicon-based fine particles with respect to 100 parts by mass of the silane compound.

[54] The method according to any one of [44] to [53], further including
before Step (p),
(p′) providing a silicon-based fine particle dispersion solution containing the silicon-based fine particles, the dispersant, an acid catalyst, and a solvent,
wherein, in Step (p),
(p-1) the silane compound is added to the silicon-based fine particle dispersion solution and the silane compound is hydrolyzed, and
(p-2) a basic catalyst or a solution thereof is added to the reaction solution obtained in Step (p-1), a hydrolyzate of the silane compound is polycondensed, and thereby the silicon-based fine particle/silicon-containing polymer composite is produced.

[55] The method according to any one of [44] to [54],
wherein, in the reaction solution during hydrolysis of the silane compound, the proportion of the acid catalyst is 0.02 parts by mass to 15 parts by mass with respect to 100 parts by mass of the silane compound, and in the reaction solution during polycondensation of the hydrolyzate of the silane compound, the proportion of the basic catalyst is 0.02 parts by mass to 15 parts by mass with respect to 100 parts by mass of the silane compound.

[56] The method according to [54] or [55],
wherein, in Step (p-1), the silane compound is added to the silicon-based fine particle dispersion solution by dropwise addition, and the silane compound is hydrolyzed, and

in Step (p-2), a basic catalyst solution is added to the reaction solution obtained in Step (p-1) by dropwise addition, a hydrolyzate of the silane compound is polycondensed, and thereby the silicon-based fine particle/silicon-containing polymer composite is produced.

[57] The method according to any one of [44] to [56],
wherein the acid catalyst is acetic acid or hydrochloric acid.

[58] The method according to any one of [44] to [57],
wherein the basic catalyst is ammonia water.

[59] The method according to any one of [44] to [58],
wherein, in Step (p-1), under conditions in which the pH of the reaction solution is in a range of 2.0 to 6.0, the silane compound is hydrolyzed, and
in Step (p-2), a basic catalyst or a solution thereof is gradually added to the reaction solution obtained in Step (p-1), and thus the pH of the reaction solution is raised to a value in a range of 7.0 to 13.5, and a hydrolyzate of the silane compound is polycondensed.

[60] The method according to any one of [44] to [59], further including
(q′) filtering and/or drying the silicon-based fine particle/silicon-containing polymer composite obtained in Step (p).

[61] The method according to any one of [44] to [60],
wherein the silane compound represented by General Formula (V) includes at least one silane compound selected from the group consisting of methyltrimethoxysilane and phenyltrimethoxysilane.

[62] A method of producing a negative electrode composition, including
obtaining a negative electrode composition using the SiOC structure according to any one of [1] to [7] as a negative electrode active material.

### BRIEF DESCRIPTION OF THE DRAWINGS

(a) and (b) of FIG. 1 show scanning electron microscope (SEM) images (with a magnification of 10,000) of SiOC structures obtained in Examples 1 and 2 in that order.

FIG. 2 is a diagram showing an SEM image (with a magnification of 1,000) of a SiOC material obtained in Comparative Example 1.

FIG. 3 shows SEM images of a SiOC material obtained in Comparative Example 2. (a) of FIG. 3 is an image with a magnification of 5,000, and (b) of FIG. 3 is an image with a magnification of 10,000.

FIG. 4 shows results obtained by measuring particle size distributions for samples collected after hydrolysis, before ammonia water as a base catalyst is added dropwise, and after the ammonia water is added dropwise when silicon nanoparticle/polysilsesquioxane composites are synthesized in Examples 1 and 2.

FIG. 5 shows results obtained by measuring particle size distributions for samples collected after hydrolysis, before ammonia water as a base catalyst is added dropwise, and after the ammonia water is added dropwise when silicon nanoparticle/polysilsesquioxane composites are synthesized in Example 4.

FIG. 6 shows results obtained by measuring particle size distributions of SiOC structures obtained in Examples 1 and 2.

(a) and (b) of FIG. 7 show transmission electron microscope (TEM) images of SiOC structures obtained in Examples 1 and 2.

FIG. 8 shows diagrams of results obtained by measuring a cycle capacity retention rate and average Coulomb efficiency of lithium ion secondary batteries produced in Example 1 and Comparative Example 1 according to a charging and discharging cycle test.

FIG. 9 is a diagram showing a configuration example of a coin type lithium ion cell.

### DESCRIPTION OF THE EMBODIMENTS

According to the disclosure, it is possible to realize a favorable cycle capacity retention rate and Coulomb efficiency in a secondary battery.

The disclosure will be described below in more detail.

### SiOC Structure

According to a first aspect of the disclosure, there is provided a SiOC structure including

(A) at least one silicon-based fine particles, and
(B) a SiOC coating layer containing at least Si (silicon), O (oxygen), and C (carbon) as constituent elements,
wherein the at least one silicon-based fine particles are covered with the SiOC coating layer, and
the average particle size according to a volume-based particle size distribution is in a range of 1 nm to 999 μm.

### Silicon-Based Fine Particles

The SiOC structure according to the first aspect of the disclosure includes at least one silicon-based fine particles.

In the disclosure, the term “silicon-based fine particles” is a concept including silicon fine particles substantially composed of only silicon and fine particles composed of a compound containing silicon in the atomic composition (for example, silica and a silicon-containing metal compound).

Any particle size (volume-based average particle size) of silicon-based fine particles can be used as long as it is in a nanometer scale to micrometer scale range. Although not particularly limited not, for example, silicon-based fine particles having a volume-based average particle size in a range of 1 nm to 2 μm can be used. In consideration of the SiOC structure that is used as a negative electrode material of a secondary battery, the volume-based average particle size (average particle size) of silicon-based fine particles is in a range of, for example, 10 nm to 500 nm, preferably 10 nm to 200 nm, and more preferably 20 nm to 100 nm.

### SiOC Coating Layer

In addition, the SiOC structure according to the first aspect of the disclosure includes a SiOC coating layer that covers the at least one silicon-based fine particles.

Here, as described above, the SiOC coating layer contains at least Si (silicon), O (oxygen), and C (carbon) as constituent elements, but in addition to these, inclusion of other elements is not excluded. In the disclosure, the SiOC coating layer is not particularly limited. Specifically, as will be described below, a SiOC coating layer which contains at least one silicon-containing polymer and in which a coating layer covering silicon-based fine particles becomes a ceramic due to a predetermined heat treatment may be used.

### Covering of Silicon-Based Fine Particles with SiOC Coating Layer

In addition, the SiOC structure according to the disclosure has one feature that “the at least one silicon-based fine particles are covered with the SiOC coating layer.”

Here, regarding a form of such “covering,” the SiOC structure need only include a structural part in which at least one silicon-based fine particles are completely covered with a SiOC coating layer, and it is not necessary for all silicon-based fine particles contained in the SiOC structure to be completely covered with a SiOC coating layer. That is, in the disclosure, specific forms of covering silicon-based fine particles with a SiOC coating layer include the following embodiments.

(i) an embodiment in which all of silicon-based fine particles contained in a SiOC structure are completely covered with a SiOC coating layer; and
(ii) an embodiment in which at least one of silicon-based fine particles contained in a SiOC structure is completely covered with a SiOC coating layer, but the remaining silicon-based fine particles are partially covered with the SiOC coating layer, and a part of the surface of the remaining silicon-based fine particles is exposed from the SiOC coating layer.

In addition, an embodiment in which, when the SiOC structure according to the disclosure contains a plurality of silicon-based fine particles, two or more of the plurality of silicon-based fine particles are directly and physically in contact with each other, and the two or more silicon-based fine particles in contact with each other are completely covered with a SiOC coating layer is also assumed.

In addition, forms of silicon-based fine particles covered with a SiOC coating layer can be confirmed by observation using an electron microscope such as an SEM or a TEM. Specific forms of the SiOC structure observed in this manner include a form of observed SEM images shown in (a) and (b) of FIG. 1 and observed TEM images shown in (a) and (b) of FIG. 7 of FIG. 7. More specifically, in the SiOC structure according to the disclosure, as observed in the SEM images and the TEM images, a form in which at least one silicon-based fine particles are covered with a SiOC coating layer to form a plurality of secondary particles, and the plurality of secondary particles are connected to each other via the SiOC coating layer is preferable. This is because, in the SiOC structure, when a form in which silicon-based fine particles are covered with a SiOC coating layer and connected to each other via the SiOC coating layer is exhibited, the SiOC structure exhibits excellent performance as a negative electrode active material and then improvement in a capacity retention rate and Coulomb efficiency in a secondary battery can be expected.

In addition, in the disclosure, the silicon-based fine particles and the SiOC coating layer are preferably chemically bonded to each other.

The SiOC structure in which the silicon-based fine particles and the SiOC coating layer are chemically bonded to each other in this manner can be specifically produced by the method to be described below.

More specifically, when a predetermined functional silane compound is hydrolyzed using an acidic catalyst, and polycondensed in the presence of silicon-based fine particles, a coating layer containing a silicon-containing polymer is produced around the silicon-based fine particles, and thus a silicon-based fine particle/silicon-containing polymer composite is obtained. According to a polycondensation reaction of the silane compound in the presence of such silicon-based fine particles, in the produced silicon-based fine particle/silicon-containing polymer composite, a form in which the surface of silicon-based fine particles and a silicon-containing polymer produced according to a polycondensation reaction are chemically bonded is exhibited. Next, when the silicon-based fine particle/silicon-containing polymer composite is heated under predetermined conditions, the coating layer becomes a ceramic and is thus converted into a SiOC structure. However, the above structure in which the surface of silicon-based fine particles and the silicon-containing polymer are chemically bonded can also be maintained even after the silicon-based fine particle/silicon-containing polymer composite is converted into a SiOC structure. That is, in the SiOC structure, the silicon-based fine particles and the SiOC coating layer are connected by the chemical framework produced according to the production of the silicon-containing polymer. Examples of such a chemical framework include a chemical framework including Si—O—C, Si—O, Si—O—Si, and the like.

### Particle Sizes of SiOC Structure

The average particle size of the SiOC structure according to the disclosure needs to be in a range of 1 nm to 999 μm. When used as a negative electrode active material in the secondary battery, the average particle size is preferably 1 nm to 600 μm, more preferably 10 nm to 500 nm, still more preferably 50 nm to 300 μm, and in some cases, may be in a range of 1 nm to 100 nm, 500 nm to 20 μm, or 1 μm to 10 μm. Here, the average particle size is an average particle size based on a volume-based particle size distribution, and can be measured according to a laser diffraction scattering method using a laser diffraction/scattering type particle size distribution measuring device (for example, MT-3300EX II commercially available from MicrotracBel Corp.).

In addition, in the SiOC structure according to the disclosure, a cumulative 10% particle size (D10), a cumulative 50% particle size (D50), and a cumulative 90% particle size (D90) obtained according to a laser diffraction scattering type particle size distribution measuring method are not particularly limited, but for example, conditions of 1 nm≤D50≤990 μm and D90/D10≤70.0; or 100 nm≤D50≤100 μm and 1.0≤D90/D10≤60.0; or 500 nm≤D50≤50 μm and 1.0≤D90/D10≤60.0; or 500 nm≤D50≤10 μm and 1.0≤D90/D10≤60.0 may be satisfied. In addition, in some embodiments, for a cumulative 10% particle size (D10), a cumulative 50% particle size (D50), and a cumulative 90% particle size (D90), conditions of 50 nm≤D10≤5 μm, 50 nm≤D50≤10 μm, and 1 μm≤D90≤50 μm may be satisfied.

### Elemental Composition of SiOC Structure

The elemental composition of the SiOC structure according to the disclosure is not particularly limited, but the SiOC structure may include, for example, within a range of 50 mass % to 90 mass % of Si, within a range of 5 mass % to 35 mass % of O, and within a range of 2 mass % to 35 mass % of C as main constituent elements, based on the total mass of the SiOC structure. In addition, in some embodiments, the SiOC structure according to the disclosure may include within a range of 60 mass % to 90 mass % of Si, within a range of 10 mass % to 35 mass % of O, and within a range of 2 mass % to 20 mass % of C as main constituent elements based on the total mass of the SiOC structure, and in another embodiment, may include within a range of 65 mass % to 82 mass % of Si, within a range of 15 mass % to 35 mass % of O, and within a range of 3 mass % to 15 mass % of C as main constituent elements. Here, it should be noted that the SiOC structure according to the disclosure may include other elements as constituent elements in addition to Si, O and C.

### Silicon-Based Fine Particle/Silicon-Containing Polymer Composite

According to a second aspect of the disclosure, there is provided a silicon-based fine particle/silicon-containing polymer composite, including

(A) at least one silicon-based fine particles, and
(B) a coating layer containing a silicon-containing polymer,
wherein the at least one silicon-based fine particles are covered with the coating layer, and
the average particle size based on a volume-based particle size distribution is in a range of 1 nm to 999 μm.

Hereinafter, the silicon-based fine particle/silicon-containing polymer composite according to the disclosure will be described.

Here, since silicon-based fine particles included in the silicon-based fine particle/silicon-containing polymer composite according to the disclosure are the same as those described in the above SiOC structure, descriptions thereof will be omitted.

### Coating Layer Containing Silicon-Containing Polymer

The “coating layer containing a silicon-containing polymer” as a constituent component of the silicon-based fine particle/silicon-containing polymer composite according to the disclosure is interpreted literally and contains a silicon-containing polymer as a constituent component. In addition, for the “coating layer to contain a silicon-containing polymer,” it is sufficient for a covering layer (that is, a coating layer) to be formed on the surface of at least one silicon-based fine particles, and the method of producing the same or the method of forming the same is not particularly limited.

In addition, in the disclosure, the “silicon-containing polymer” is interpreted literally, and any polymer containing silicon as a constituent element is sufficient. The silicon-containing polymer will be described below in detail.

### Covering of Silicon-Based Fine Particles with Coating Layer

The silicon-based fine particle/silicon-containing polymer composite according to the disclosure has one feature that “the at least one silicon-based fine particles are completely covered with the coating layer.

Here, regarding a form of such “covering,” similar to “covering” of the above SiOC structure, it is sufficient that at least one silicon-based fine particles have a structural part completely covered with the coating layer, and it is not necessary for all silicon-based fine particles contained in the silicon-based fine particle/silicon-containing polymer composite to be completely covered with the coating layer. That is, in the disclosure, specific forms of covering of silicon-based fine particles with a coating layer include the following embodiments.

(i) an embodiment in which all of silicon-based fine particles contained in a silicon-based fine particle/silicon-containing polymer composite are completely covered with a coating layer; and
(ii) an embodiment in which at least one of silicon-based fine particles contained in a silicon-based fine particle/polysilsesquioxane composite is completely covered with a coating layer, but the remaining silicon-based fine particles are partially covered with the coating layer, and a part of the surface of the remaining silicon-based fine particles is exposed from the coating layer.

In addition, an embodiment in which, in the silicon-based fine particle/polysilsesquioxane composite according to the disclosure, when a plurality of silicon-based fine particles are contained, two or more of the plurality of silicon-based fine particles are in contact with each other, and two or more silicon-based fine particles in contact with each other are completely covered with the coating layer is also assumed.

Here, like confirmation of the form of the SiOC structure, regarding a form of the covering of silicon-based fine particles with a coating layer, the form of the silicon-based fine particle/silicon-containing polymer composite can be confirmed by observation using an electron microscope such as an SEM or a TEM.

In addition, in the disclosure, in the silicon-based fine particle/silicon-containing polymer composite, the silicon-based fine particles and the coating layer are preferably chemically bonded. Specifically, as will be described below, the silicon-based fine particle/polysilsesquioxane composite of the disclosure is produced through hydrolysis and polycondensation of a silane compound having a hydrolyzable group. That is, when a predetermined functional silane compound is hydrolyzed using an acidic catalyst and polycondensed in the presence of silicon-based fine particles, a coating layer containing a silicon-containing polymer is produced around the silicon-based fine particles, and a silicon-based fine particle/silicon-containing polymer composite is produced.

In this manner, when the silicon-based fine particle/silicon-containing polymer composite is produced by a production method based on hydrolysis and polycondensation of the predetermined silane compound, the silicon-based fine particles and the silicon-containing polymer coating layer are chemically bonded to each other. Examples of a form in which such silicon-based fine particles and the silicon-containing polymer coating layer are chemically bonded to each other include a chemical framework including Si particle —O—, Si particle —O—Si—, and the like.

### Silicon-Containing Polymer

The “silicon-containing polymer” in the “coating layer containing a silicon-containing polymer” will be described below in detail.

As will be described below, the “silicon-containing polymer” is produced according to hydrolysis and polycondensation of a predetermined hydrolyzable silane compound. In the disclosure, more specifically, the silicon-containing polymer may include at least one polymer selected from the group consisting of polycarbosilanes, polysilanes, polysiloxanes, and polysilsesquioxanes.

Generally, the polycarbosilane contains at least one of structural units represented by the following (1) to (3).

(R¹R²SiCH₂) (1)

(R¹Si(CH₂)_{1.5}) (2)

(R¹R²R³Si(CH₂)_{0.5}) (3)

Here, R¹, R² and R³ each independently represent a hydrogen atom or a hydrocarbon group having 1 to 20 carbon atoms (preferably, 1 to 6 carbon atoms). Examples of hydrocarbon groups include alkyl groups such as a methyl group, an ethyl group, a propyl group and a butyl group; alkenyl groups such as a vinyl group and an allyl group; and aryl groups such as a phenyl group.

In addition, in the hydrocarbon group, any part is optionally substituted with a heteroatom such as a silicon, nitrogen or boron atom.

In addition, for example, in the polycarbosilane, any part is optionally substituted with various metal groups such as aluminum, chromium and titanium. Since polycarbosilanes of various types in which substitution is performed with such a metal group are known in the related art together with their synthesis steps, such known synthesis steps may be combined with the method of producing a SiOC structure according to the disclosure.

In the disclosure, examples of a polysilane that can be used as a silicon-containing polymer include various polysilanes including at least one of the following structural units (4) to (6).

(R¹R²R³Si) (4)

(R¹R²Si) (5)

(R³Si) (6)

Here, R¹, R², and R³ are as described above. In a specific embodiment, a polysilane as a silicon-containing polymer may include at least one structural unit selected from the group consisting of (Me₂Si), (PhMeSi), (MeSi), (PhSi), (ViSi), (PhHSi), (MeHSi), (MeViSi), (Ph₂Si), (PhViSi), and (Me₃Si). Here, Me represents a methyl group, Ph represents a phenyl group, and Vi represents a vinyl group.

In addition, the polysilane may be substituted with any metal group, that is, may include a predetermined number of repeating units of any metal—Si. Examples of suitable metal groups include aluminum, chromium and titanium.

In the disclosure, examples of the polysiloxane that can be used as a silicon-containing polymer include various polysiloxanes including the following structural unit (7).

(R¹R²R³SiO_{0.5})_{w}(R⁴R⁵SiO)ₓ(R⁶SiO_{1.5})_{y}(SiO_{4/2})_{z} (7)

Here, R¹, R², R³, R⁴, R⁵ and R⁶ each independently represent a hydrogen atom or a hydrocarbon group having 1 to 20 carbon atoms (preferably, 1 to 6 carbon atoms) as described for R¹, R², and R³. In addition, w, x, y and z are molar ratios of respective constituent components indicated, and w=0 to 0.8, x=0.3 to 1, y=0 to 0.9, z=0 to 0.9, and w+x+y+z=1.

Specific examples of a siloxane unit that can be used in the disclosure include (MeSiO_{1.5}), (PhSi_{1.5}), (ViSi_{1.5}), (HSi_{1.5}), (PhMeSiO), (MeHSiO), (PhViSiO), (MeViSiO), (Ph₂SiO), (Me₂SiO), (Me₃SiO_{0.5}), (Ph₂ViSiO_{0.5}), (Ph₂HSiO_{0.5}), (H₂ViSiO_{0.5}), (Me₂ViSiO_{0.5}), and (SiO_{4/2}). Here, Me represents a methyl group, Ph represents a phenyl group, and Vi represents a vinyl group.

In the disclosure, the polysilsesquioxane that can be used as a silicon-containing polymer mainly includes a polysilsesquioxane including a unit of (RSiO_{3/2})_{X}. Here, R represents a saturated or unsaturated, linear, branched or cyclic group hydrocarbon group, for example, —CₙH₂ₙ₊₁ (n is an integer in a range of 1 to 20.), and more specifically, may be a methyl, ethyl, propyl, butyl, pentyl, hexyl, heptyl, octyl, nonyl, decyl, dodecyl, tridecyl, tetradecyl, hexadecyl, octadecyl or eicosyl group, and may be an aryl group, and particularly, a phenyl group or a tolyl group, and may be a cycloalkyl group, and particularly, a cyclobutyl group, a cyclopentyl or cyclohexyl group, and may be an alkenyl group, and particularly, a vinyl or allyl group, and alternatively, may be an aralkyl group containing a 2-phenylethyl or benzyl. R may contain a heteroatom therein, and particularly, contain a nitrogen or halogen atom, and preferably, R represents a methyl, ethyl, propyl or phenyl group. R's may be a combination of two or more different groups. x represents the number of repeating units, and is an integer of 1 or more, and for example, can be any integer selected from the range of 4 to 10,000.

In a preferable embodiment, the silicon-containing polymer, which is a main component of the coating layer covering the silicon-based fine particles, includes a polysilsesquioxane. In a more preferable embodiment, the silicon-containing polymer is substantially composed of a polysilsesquioxane, and a silicon-based fine particle/silicon-containing polymer composite in which at least one silicon-based fine particles are covered with a coating layer composed of a silicon-containing polymer that is substantially composed of a polysilsesquioxane in this manner is preferably produced in Step (p). The silicon-based fine particle/silicon-containing polymer composite having such a structure can be obtained by hydrolysis and polycondensation of any trifunctional organosilane (organotrialkoxysilane, organotrichlorosilane, etc.) under the above conditions and range of procedures in Step (p).

The polysilsesquioxane may include at least one selected from the group consisting of ladder-type polysilsesquioxanes, basket type polysilsesquioxanes such as POSS (T^{R}₈), incomplete basket type polysilsesquioxanes and other types of polysilsesquioxanes. Since various types of polysilsesquioxanes are known together with their synthesis methods, such synthesis methods can be used in the disclosure (Chemistry and application development of silsesquioxane materials, CMC Publishing Co., Ltd., 2013, popular edition, etc.).

More specifically, in a specific embodiment, the silicon-containing polymer may include at least one selected from the group consisting of polysilsesquioxanes each having a polysilsesquioxane structure represented by the following General Formulae (I), (II), (III), and (IV).

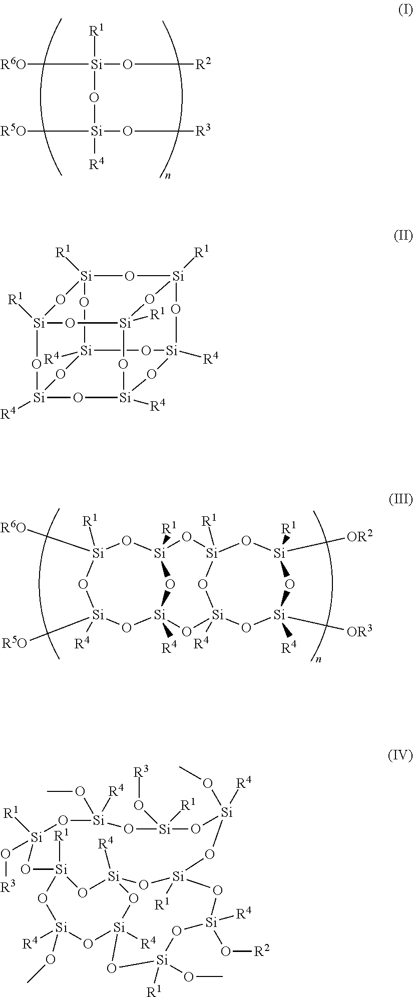

In the formula, R¹ and R⁴ are each independently selected from the group consisting of a substituted or unsubstituted alkyl group having 1 to 45 carbon atoms, a substituted or unsubstituted aryl group, and a substituted or unsubstituted arylalkyl group, and in the alkyl group having 1 to 45 carbon atoms, any hydrogen atom is optionally substituted with a halogen atom, any —CH₂— is optionally substituted with —O—, —CH═CH—, a cycloalkylene group or a cycloalkenylene group, and in an alkylene group in the substituted or unsubstituted arylalkyl group, any hydrogen atom is optionally substituted with a halogen atom, and any —CH₂— is optionally substituted with —O—, —CH═CH— or a cycloalkylene group,

R², R³, R⁵ and R⁶ are each independently selected from the group consisting of a hydrogen atom, a substituted or unsubstituted alkyl group having 1 to 45 carbon atoms, a substituted or unsubstituted aryl group, and a substituted or unsubstituted arylalkyl group, and in the alkyl group having 1 to 45 carbon atoms, any hydrogen atom is optionally substituted with a halogen atom, any —CH₂— is optionally substituted with —O—, —CH═Ch—, a cycloalkylene group, a cycloalkenylene group or —SiR¹₂—, and in an alkylene group in the substituted or unsubstituted arylalkyl group, any hydrogen atom is optionally substituted with a halogen atom, any —CH₂— is optionally substituted with —O—, —CH═CH—, a cycloalkylene group, a cycloalkenylene group or —SiR¹₂—, and n represents an integer of 1 or more.

In the disclosure, “halogen” is understood literally, and represents fluorine, chlorine, bromine, iodine, or the like, and particularly, fluorine or chlorine is preferable.

In addition, in the silicon-based fine particle/silicon-containing polymer composite according to the disclosure, regarding a “coating layer containing a silicon-containing polymer,” more specifically, a silicon-containing polymer layer may be formed on the surface of silicon-based fine particles through hydrolysis and polycondensation of a predetermined silane compound in the presence of silicon-based fine particles according to a method of producing a silicon-based fine particle/silicon-containing polymer composite according to the disclosure to be described below.

### Particle Size of Silicon-Based Fine Particle/Silicon-Containing Polymer Composite

The average particle size of the silicon-based fine particle/silicon-containing polymer composite according to the disclosure needs to be in a range of 1 nm to 999 μm. When used as a negative electrode active material in a secondary battery, the average particle size may be in a range of preferably 1 nm to 100 μm, more preferably 10 nm to 60 μm, and still more preferably 100 nm to 1 μm.

Here, the average particle size is an average particle size based on a volume-based particle size distribution, and can be measured according to a laser diffraction scattering method using a laser diffraction/scattering type particle size distribution measuring device (for example, MT-3300EX II commercially available from MicrotracBel Corp.).

In addition, in the silicon-based fine particle/silicon-containing polymer composite according to the disclosure, a cumulative 10% particle size (D10), a cumulative 50% particle size (D50), and a cumulative 90% particle size (D90) obtained according to a laser diffraction scattering type particle size distribution measuring method are not particularly limited, but for example, conditions of 1 nm≤D50≤990 μm and D90/D10≤70.0, or 10 nm≤D40≤100 μm and 1.0≤D90/D10≤50.0; or 100 nm≤D50≤40 μm and 1.0≤D90/D10≤40.0; or 200 nm≤D50≤30 μm and 1.0≤D90/D10≤30.0; or 300 nm≤D50≤30 μm and 1.0≤D90/D10≤20.0 may be satisifed.

In addition, in some embodiments, for a cumulative 10% particle size (D10), a cumulative 50% particle size (D50), and a cumulative 90% particle size (D90), conditions of 50 nm≤D10≤10 μm, 50 nm≤D50≤50 μm, and 500 nm≤D90≤150 μm may be satisfied.

### Method of Producing Silicon-Based Particle/Silicon-Containing Polymers Composite

According to a third aspect of the disclosure, there is provided a method of producing a silicon-based fine particle/silicon-containing polymer composite, including
producing a silicon-based fine particle/silicon-containing polymer composite according to the disclosure obtained by hydrolyzing a silane compound represented by

(p) General Formula (V):

R¹ₙSiX¹₄₋ₙ (V)
(in the formula, R¹ represents a hydrogen atom, a hydroxyl group, or a substituted or unsubstituted hydrocarbon group having 1 to 45 carbon atoms, and in the hydrocarbon group having 1 to 45 carbon atoms, any hydrogen atom is optionally substituted with a halogen atom, and any —CH₂— is optionally substituted with —O—, —CH═CH—, a cycloalkylene group or a cycloalkenylene group,
X¹ represents a halogen atom or an alkyloxy having 1 to 6 carbon atoms or an acetoxy group,
when there are a plurality of R¹'s and X¹'s, they are independent from each other, and
n represents an integer of 0 to 3) and then polycondensing in the presence of a dispersant and silicon-based fine particles.

Hereinafter, a method of producing a silicon-based fine particle/silicon-containing polymer composite according to the disclosure will be described in detail. Here, in this specification, unless otherwise specified, “the production method according to the disclosure” or “the production method of the disclosure” refers to any of the “method of producing a silicon-based fine particle/silicon-containing polymer composite,” “method of producing a SiOC structure,” “method of producing a negative electrode composition,” “method of producing a negative electrode,” and “method of producing a secondary battery” according to the disclosure, and as long as there is no particular contradiction, an embodiment referred to as “the production method according to the disclosure” or “the production method of the disclosure” is explicitly described in this specification as an embodiment that can be used in any of the “method of producing a silicon-based fine particle/silicon-containing polymer composite,” “method of producing a SiOC structure,” “method of producing a negative electrode composition,” “method of producing a negative electrode,” and “method of producing a secondary battery” according to the disclosure.

### Hydrolyzable Silane Compound

In a method of producing a SiOC structure according to the disclosure, first, as described above, in Step (p), a silane compound represented by General Formula (V) is hydrolyzed as a hydrolyzable silane compound, the obtained hydrolysate is polycondensed in the presence of a dispersant and silicon-based fine particles, and thus a silicon-based fine particle/silicon-containing polymer composite in which at least one silicon-based fine particles are covered with a coating layer containing at least one silicon-containing polymer is produced.

Regarding a preferable embodiment, an embodiment in which, in General Formula (V), n=1, R¹ represents a hydrocarbon group having 1 to 10 carbon atoms, and three Xⁱ's each independently represent a halogen atom or an alkyloxy having 1 to 6 carbon atoms or an acetoxy group can be used.

In addition, in some embodiments, regarding a silane compound represented by General Formula (V), a silane compound represented by the following General Formula (VI) may be used.

R¹⁰Si(R⁷)(R⁸)(R⁹) (VI)

(In the formula, R⁷, R⁸ and R⁹ each independently represent a hydrogen atom, a halogen atom, a hydroxyl group or an alkyloxy group having 1 to 4 carbon atoms, R¹⁰ is selected from the group consisting of a substituted or unsubstituted alkyl group having 1 to 45 carbon atoms, a substituted or unsubstituted aryl group, and a substituted or unsubstituted arylalkyl group, and in the alkyl group having 1 to 45 carbon atoms, any hydrogen atom is optionally substituted with a halogen atom, any —CH₂— is optionally substituted with —O—, —CH═CH—, a cycloalkylene group or a cycloalkenylene group, and in an alkylene group in the substituted or unsubstituted arylalkyl group, any hydrogen atom is optionally substituted with a halogen atom, and any —CH₂— is optionally substituted with —O—, —CH═CH—, a cycloalkylene group or a cycloalkenylene group.)

Here, in General Formula (VI), regarding a substituent for the alkyl group substituted, a halogen atom, an alkyl group having 1 to 10 carbon atoms, an alkenyl group having 2 to 10 carbon atoms, an alkoxy group having 1 to 5 carbon atoms, or an aromatic group such as a phenyl group and a naphthyl group is preferable.

Examples of a silane compound represented by General Formula (V) mainly include organotrichlorosilanes and organotrialkoxysilanes.

More specifically, substituted or unsubstituted alkyltrialkoxysilane compounds such as methyltrimethoxysilane, methyltriethoxysilane, ethyltrimethoxysilane, ethyltriethoxysilane, trimethoxy(propyl)silane, n-butyltriethoxysilane, isobutyltrimethoxysilane, n-pentyltriethoxysilane, n-hexyltrimethoxysilane, isooctyltriethoxysilane, decyltrimethoxysilane, methyldimethoxyethoxysilane, methyldiethoxymethoxysilane, 2-chloroethyltriethoxysilane, methoxymethyltriethoxysilane, methylthiomethyltriethoxysilane, methoxycarbonylmethyltriethoxysilane, 2-acryloyloxyethyltrimethoxysilane, and 3-methacryloyloxypropyltriethoxysilane; substituted or unsubstituted aryltrialkoxysilane compounds such as phenyltrimethoxysilane, 4-methoxyphenyltrimethoxysilane, 2-chlorophenyltrimethoxysilane, phenyltriethoxysilane, 2-methoxyphenyltriethoxysilane, phenyldimethoxyethoxysilane, and phenyldiethoxymethoxysilane and the like may be exemplified. In particular, the silane compounds represented by General Formula (I) preferably include at least one silane compound selected from the group consisting of methyltrimethoxysilane and phenyltrimethoxysilane.

In addition, in addition to/in place of the organotrichlorosilanes and organotrialkoxysilanes described above, other types of silane compounds such as dialkoxydialkylsilanes may be used.

Hereinafter, conditions for hydrolysis and polycondensation of the silane compound in Step (p) will be described.

### Solvent

The solvent constituting the reaction solution in Step (p) is not particularly limited as long as hydrolysis/polycondensation of the silane compound can proceed. Specifically, water may be included in order to assist hydrolysis of the silane compound. In addition to water, organic solvents including alcohols such as methanol, ethanol, and 2-propanol, ethers such as diethyl ether, ketones such as acetone and methylethyl ketone, and aromatic hydrocarbon solvents such as hexane, DMF, and toluene may be exemplified. These may be used alone or two or more thereof may be used in combination.

### Catalyst

The reaction solution in Step (p) may optionally contain a catalyst that promotes hydrolysis and polycondensation of the siliconized compound. Specific examples of such a catalyst include an acidic catalyst and a basic catalyst, and these may be used alone or a combination of an acidic catalyst and a basic catalyst may be used.

Regarding an acidic catalyst, any of organic acids and inorganic acids can be used.

Specific examples of organic acids include formic acid, acetic acid, propionic acid, oxalic acid, and citric acid, and specific examples of inorganic acids include hydrochloric acid, sulfuric acid, nitric acid, and phosphoric acid. Among these, it is preferable to use hydrochloric acid and/or acetic acid because they allow the hydrolysis reaction and the subsequent polycondensation reaction to be easily controlled, the cost is reduced, and the treatment after the reaction is also easy.

Examples of basic catalysts include basic compounds such as sodium hydroxide, calcium hydroxide, potassium hydroxide, and ammonia, and quaternary ammonium salts such as tetramethylammonium hydroxide, tetraethylammonium hydroxide, tetrabutylammonium hydroxide, benzyltrimethylammonium hydroxide, benzyltriethylammonium hydroxide, ammonium fluoride, tetrabutylammonium fluoride, benzyltrimethylammonium chloride, and benzyltriethylammonium chloride. In the disclosure, any substance that functions as a basic catalyst in the hydrolysis/polycondensation reaction can be used without particular limitation, and use of ammonia water is convenient because ammonia water is inexpensive and easy to handle.

In addition, when a halogenated silane such as trichlorosilane is used as the silane compound, an acidic aqueous solution is formed in the presence of water, and “acidic conditions” under which hydrolysis and polycondensation of the silane compound can proceed are realized. Accordingly, when a halogenated silane is used in this manner, since the hydrolysis and polycondensation reaction proceed without a particular acidic catalyst being separately added, there is no need to separately add a catalyst. That is, in Step (p), the acidic catalyst is also referred to as an optional component.

### Dispersant

In the disclosure, the dispersant refers to a substance having a function of promoting a dispersion state in a reaction system of oligomer molecules generated according to hydrolysis and polycondensation of the silane compound. In addition, the dispersant is preferably a substance having a function of inhibiting the occurrence of phase separation in a reaction system in which oligomers are produced according to hydrolysis and polycondensation of the predetermined silane compound.

More specific examples of a substance that can exhibit such a function include a surfactant. Regarding the dispersant in the disclosure, among surfactants, a nonionic surfactant is preferably used.

Examples of nonionic surfactants include fatty acid nonionic surfactants (for example, sucrose fatty acid esters, sorbitan fatty acid esters, polyoxyethylene sorbitan fatty acid esters, and fatty acid alkanolamides); higher alcohol nonionic surfactants (for example, polyoxyethylene alkyl ethers); and alkylphenolic nonionic surfactants (for example, polyoxyethylene alkyl phenyl ethers). Regarding the dispersant used in the disclosure, among them, polyoxyethylene sorbitan fatty acid esters (polysorbates) are preferably used. In addition, more specifically, polysorbate 20, polysorbate 40, polysorbate 60, or polysorbate 80 is preferably used, and polysorbate 80 (Tween 80) is particularly preferable.

Here, regarding the dispersant, one type of substance may be used, or two or more types of substances may be used in combination.

In the production method according to the disclosure, in this manner, a hydrolysate of a predetermined silane compound is polycondensed in the presence of a dispersant and silicon-based fine particles, and thus covering of the silicon-based fine particles with the coating layer is realized. When a dispersant is present in the reaction system, oligomers that are produced according to polycondensation of the hydrolysate of the predetermined silane compound are produced as relatively uniform particles, and moreover, the oligomer particles are dispersed in the reaction solution. Thus, silicon-based fine particles are incorporated into the oligomer particles in a dispersion state, and as a result, it is speculated that a silicon-based fine particle/silicon-containing polymer composite in the particle form in which silicon-based fine particles are covered with a polysilsesquioxane coating layer can be produced. In addition, since the dispersant can function as a phase separation inhibitor, if there is no dispersant, a rapid polycondensation reaction occurs initially, and even under reaction conditions that may cause phase separation of oligomers produced in the reaction solution, since there is a phase separation agent in the production method according to the disclosure, it is considered that the phase separation is inhibited, and it is possible to effectively inhibit production of an oligomer aggregate. As a result, the predetermined silicon-based fine particle/polysilsesquioxane composite or SiOC structure according to the disclosure can be produced.

### Silicon-Based Fine Particles

Silicon-based fine particles are a concept including silicon fine particles substantially composed of only silicon and fine particles composed of a compound containing silicon in the atomic composition (for example, silica, silicon-containing metal compound) as described above, and can be used without any particular limitation in the range. Silicon-based fine particles are preferably silicon fine particles substantially composed of only silicon, and particularly, use of silicon nano powder is convenient because various commercial products are available. Here, conditions for the particle size of silicon-based fine particles and the like are the same as those described for the SiOC structure.

### Conditions for Hydrolysis and Polycondensation Reaction

Next, reaction conditions for hydrolysis and polycondensation in Step (p) will be described.

The proportion of the silane compound in the reaction solution is not particularly limited, but is for example, about 0.1 parts by mass to about 30 parts by mass, preferably about 0.1 parts by mass to about 25 parts by mass, and more preferably about 0.5 parts by mass to about 20 parts by mass with respect to 100 parts by mass of the reaction solution. Using such a range as a guide, the proportion may be appropriately set together with a proportion of silicon-based fine particles added in consideration of physical properties such as the atomic composition ratio, particle form and size that are desired to be realized in the finally produced silicon-based fine particle/polysilsesquioxane composite or SiOC structure. Here, this range related to the proportion of the silane compound can be used for both hydrolysis and polycondensation.

The proportion of silicon-based fine particles added is not particularly limited, and may be appropriately set together with the silane compound in consideration of the atomic composition ratio and desired battery characteristics that are desired to be realized in the finally produced silicon-based fine particle/polysilsesquioxane composite or SiOC structure. The proportion of silicon-based fine particles added is, for example, about 0.1 parts by mass to about 70 parts by mass, preferably about 1.0 part by mass to about 60.0 parts by mass, more preferably about 5.0 parts by mass to about 55 parts by mass, and particularly preferably about 10 parts by mass to about 50 parts by mass with respect to 100 parts by mass of the silane compound.

The proportion of the solvent is not particularly limited as long as the hydrolysis and/or polycondensation reaction proceeds, and covering of the silicon-based fine particles with the coating layer can be realized, and is, for example, about 100 parts by mass to about 5,000 parts by mass, preferably about 200 parts by mass to about 4,000 parts by mass, more preferably about 300 parts by mass to about 4,000 parts by mass, and particularly preferably about 1,200 parts by mass to about 3,500 parts by mass, and in some cases, in a range of about 2,500 parts by mass to 3,500 parts by mass, with respect to 100 parts by mass of the silane compound. Here, when this proportion range is used, as described above, only water may be used as the solvent, or a solvent in which water and anther solvent (an alcohol, an organic solvent, or the like) are mixed may be used. In addition, the proportion of the solvent contained in the reaction solution is, for example, in a range of 20 to 200 parts by mass, preferably about 30 parts by mass to about 200 parts by mass, preferably about 30 parts by mass to about 150 part by mass, and in some cases, about 60 parts by mass to about 150 parts by mass, with respect to the mass of silicon-based fine particles. This is because, when this range related to the proportion of the solvent is used, silicon-based fine particles are uniformly covered with the coating layer containing a silicon-containing polymer, and the occurrence of aggregates can be effectively inhibited.

Here, this range related to the proportion of the solvent can be used for both hydrolysis and polycondensation.

When an acid catalyst is added, its proportion is not particularly limited as long as it is appropriately adjusted so that desired hydrolysis and polycondensation reactions occur, and is, for example, about 0.02 parts by mass to about 15 parts by mass, preferably about 0.02 parts by mass to about 10 parts by mass, and more preferably about 0.02 to about 8 parts by mass, and in some cases, about 0.04 parts by mass to about 7 parts by mass, and about 0.08 parts by mass to about 6 parts by mass, with respect to 100 parts by mass of the silane compound. In addition, when a basic catalyst is added, its proportion is not particularly limited as long as it is appropriately adjusted so that desired hydrolysis and polycondensation reactions occur as in the acid catalyst, and is, for example, about 0.02 parts by mass to about 15 parts by mass, preferably about 0.1 parts by mass to about 10 parts by mass, and more preferably about 0.5 parts by mass to about 8 parts by mass, and in some cases, about 0.8 parts by mass to about 7 parts by mass, about 0.9 parts by mass to about 6 parts by mass, and about 1 parts by mass to about 5 parts by mass, with respect to 100 parts by mass of the silane compound.

This is because, when these ranges related to the proportions of the acid catalyst and the basic catalyst are used, silicon-based fine particles are uniformly covered with the coating layer containing a silicon-containing polymer, and the occurrence of aggregates can be effectively inhibited.

The proportion of the dispersant is not particularly limited as long as it is appropriately adjusted so that oligomer particles produced from the hydrolysis and polycondensation reaction of the silane compound are obtained in a desired dispersion state, and is, for example, about 1 parts by mass to about 200 parts by mass, preferably about 1 parts by mass to about 150 parts by mass, more preferably about 10 parts by mass to about 80 parts by mass, and still more preferably about 10 to about 60 parts by mass, and in some cases, about 20 parts by mass to about 50 parts by mass, about 25 parts by mass to about 40 parts by mass, with respect to 100 parts by mass of the silane compound.

In addition, the hydrolysis and/or polycondensation reaction temperature is not particularly limited, and is, for example, in a range of about −20° C. to about 80° C., preferably about 0° C. to about 70° C., still more preferably about 0° C. to about 40° C. or about 10° C. to about 30° C., and particularly preferably about 10° C. to about 25° C. In order to more effectively inhibit the occurrence of polysilsesquioxane composite aggregates, the hydrolysis and/or polycondensation temperature is preferably about 30° C. or lower, more preferably about 29° C. or lower, still more preferably about 28° C. or lower, about 27° C. or lower, or about 26° C. or lower, and particularly preferably about 25° C. or lower. Regarding the temperature range, a temperature range obtained by combining the upper limit temperature with 10° C. or higher as the lower limit temperature can be used as a specific embodiment.

The hydrolysis and/or polycondensation reaction time is not particularly limited, and is, for example, about 0.5 hours to about 100 hours, and in some cases, about 1 hour to about 80 hours, or about 1 hour to about 6 hours.

The pH of the reaction solution is not particularly limited as long as it is appropriately adjusted so that the hydrolysis and polycondensation reaction of the silane compound favorably proceed, and may be selected generally in a range of 0.8 to 12 according to a specific silane compound used and the shape and properties of a desired organosilicon compound (silicon-containing polymer) product. Here, the pH of the reaction solution can be adjusted using an acid containing the above acidic catalyst.

In addition, the order of addition of components and a method of adding components are not particularly limited as long as a predetermined silicon-based fine particle/silicon-containing polymer composite or SiOC structure of the disclosure can be obtained. Generally, in consideration of properties of a silane compound used and the shape and properties of a desired organosilicon compound (silicon-containing polymer) product, in Step (p), first, the silane compound is hydrolyzed and, in the presence of silicon-based fine particles, a polycondensation reaction may be then caused to synthesize a silicon-based fine particle/silicon-containing polymer composite.

More specifically, a solvent, an acid catalyst, a dispersant and silicon nanoparticles are put into a reaction container, and a predetermined dispersion treatment such as ultrasonication is performed on the obtained mixture as necessary, and thereby a silicon nanoparticle dispersion solution may be prepared. Next, the silane compound is added (preferably, added dropwise) to the silicon nanoparticle dispersion solution and while stirring or the like as necessary, the silane compound may be hydrolyzed at a predetermined time and temperature. Next, a basic catalyst is added to the obtained reaction solution as necessary, and while stirring or the like as necessary, the polycondensation reaction of the hydrolysate of the silane compound can be performed at a predetermined time and temperature.

Here, in the above procedure, as necessary, the atmosphere of the reaction system (specifically, in the reaction container) related to the hydrolysis/polycondensation may be replaced with a predetermined gas atmosphere (for example, an inert gas such as nitrogen, argon, or helium gas).

More specifically, in a specific embodiment, the production method according to the disclosure may further include (p′) providing a silicon-based fine particle dispersion solution containing the silicon-based fine particles, the dispersant, the acid catalyst, and the solvent before Step (p).

In addition, in some embodiments, in a method of producing a silicon nanoparticle/silicon-containing polymer composite according to the disclosure, in Step (p),

(p-1) the silane compound is added to the silicon-based fine particle dispersion solution and the silane compound is hydrolyzed, and
(p-2) next, a basic catalyst or a solution thereof is added to the reaction solution obtained in Step (p-1), the hydrolysate of the silane compound is polycondensed, and thereby the silicon-based fine particle/silicon-containing polymer composite may be produced.

In Step (p-1), in order for the desired hydrolysis to proceed sufficiently, acidic conditions in which a hydrolysis reaction rate is higher than a polycondensation reaction rate and a hydrolysis reaction proceeds dominantly may be used. The pH range in which such acidic conditions are realized varies depending on the type of the silane compound as a raw material, and is generally a pH of about 2.0 to about 6.0, and preferably a pH of about 2.5 to about 5.0, and in some cases, it can be adjusted to about 3.0 to about 4.5 or about 3.0 to about 4.0. Here, the degree of the acidity affects the balance of hydrolysate formation, the reaction time, the amount of partial condensates, the number of condensations, and the like, but does not significantly affect the particle size.

Here, the above acidic catalyst may be used as an acid that can be used to prepare a medium in the acidic pH range, and hydrochloric acid and acetic acid are preferable because they allow the hydrolysis reaction and the subsequent polycondensation reaction to be easily controlled, are readily available and easily adjust the pH, and among these, acetic acid is most preferably used. For example, when a dilute acetic acid aqueous solution is used as an acidic aqueous medium, the pH value is about 5.0 to 5.8, but such a numeric range of pH can be used as a specific embodiment of the disclosure.

Next, in Step (p-2), more specifically, an appropriate amount of a basic catalyst solution is added to the reaction solution obtained in Step (p-1), and while stirring or the like as necessary, the polycondensation reaction of the hydrolysate is performed at a predetermined reaction temperature and time.

Here, the reaction temperature and the reaction time are as described above. However, in Step (p-1), in order to prevent a rapid hydrolysis reaction and polycondensation reaction, it is preferable to slowly add the silane compound to the silicon nanoparticle dispersion solution by dropwise addition. In addition, also in Step (p-2), for the same purpose, it is preferable to add a basic catalyst to the reaction solution by dropwise addition.

More specifically, in order to inhibit aggregation of the silicon nanoparticle/silicon-containing polymer composite, a relatively small proportion of an acid in the silicon nanoparticle dispersion solution is preferable, and the silane compound is slowly added to the reaction solution by dropwise addition preferably at 25° C. or lower, and in Step (p-2), the basic catalyst is gradually added to the reaction solution, and the pH of the reaction solution may be slowly increased to a value range of about 7.0 to about 13.5, preferably about 7.5 to about 13.0, more preferably about 7.8 to about 12.5, still more preferably about 8.0 to about 12.0, and most preferably about 9.0 to about 12.0, for example, a value of about 10.7.

The method of producing a silicon nanoparticle/silicon-containing polymer composite according to the disclosure may optionally further include at least one of the following steps.

(a) After the silicon-based fine particle/polysilsesquioxane coating layer composite is produced through the hydrolysis reaction and the polycondensation reaction, optionally, liquid fractions are separated and removed by a method such as filtration separation (for example, pressure filtration), solid-liquid separation, solvent distillation, centrifugation or decantation. Regarding a method of separating such a solid content and a liquid, various general-purpose techniques are known to those skilled in the art and thus these can be appropriately used.
(b) In addition, the obtained solid fraction is washed with water or washed with an organic solvent, and the organic solvent is distilled off and dried (drying under a reduced pressure and/or drying by heating), and the like.

Here, in the method of producing a SiOC structure according to the disclosure, the obtained solid fraction of the silicon-based fine particle/silicon-containing polymer composite can be subjected to Step (q) as an object to be heated as will be described below in detail.

### Method of Producing a SiOC Structure

According to a fourth aspect of the disclosure, there is provided a method of producing a SiOC structure, including

(q) heating the silicon-based fine particle/polysilicon-containing polymer composite under a non-oxidizing gas atmosphere and converting it into a SiOC structure.

The heat treatment conditions in the embodiment of Step (q) may be appropriately set in consideration of the type, capacity, and the like of a heat treatment device used. For example, under a non-oxidizing atmosphere, heating may be performed at a rate of temperature increase of 0.5° C./min to 200° C./min, preferably 0.5° C./min to 100° C./min, more preferably 1° C./min to 50° C./min, still more preferably 1° C./min to 30° C./min, and particularly preferably 2° C./min to 10° C./min, in a temperature range of 400° C. to 1,800° C., preferably 600° C. to 1,400° C., and more preferably 900° C. to 1,300° C., and at the temperature, a heat treatment may be performed for a range of 5 minutes to 20 hours, preferably 30 minutes to 10 hours, and more preferably 1 hour to 8 hours. However, heat treatment conditions such as the rate of temperature increase, the heat treatment temperature, and the heating time are not particularly limited as long as required minimum heat treatment conditions are appropriately selected in consideration of properties of polysilsesquioxane used as a raw material, physical properties and other properties of a desired SiOC structure, productivity, and economic efficiency.

Here, the “non-oxidizing gas atmosphere” in the disclosure includes an inert gas atmosphere, a reducing atmosphere, and a mixed atmosphere including these atmospheres in combination. Examples of inert gas atmospheres include inert gases such as nitrogen, argon, and helium gas. These inert gases may be used alone or two or more thereof may be used in combination. In addition, any inert gas that is generally used is sufficient, but on having a high purity standard is preferable. The reducing atmosphere includes an atmosphere containing a reducing gas such as hydrogen. For example, a mixed gas atmosphere containing 2 volume % or more of hydrogen gas and an inert gas may be used. In addition, a hydrogen gas atmosphere itself may be used as the reducing atmosphere in some cases.

In addition, the non-oxidizing atmosphere environment may be created by replacing the atmosphere in a heat treatment furnace with the predetermined gas or supplying the predetermined gas into the furnace.

When the gas is supplied into the heat treatment furnace, the gas flow rate is not particularly limited as long as it is appropriately adjusted to be within an appropriate range according to the specification of the heat treatment furnace to be used (for example, the shape and size of the furnace), and can be about 5% to 100%/min, and preferably about 5 to 30%/min of the capacity in the furnace. More specifically, when a vacuum purge tube furnace generally used on a laboratory scale is used, the gas flow rate (purge amount) can be, for example, about 50 mL to 1 L/min, and preferably about 100 mL to 500 mL/min. In addition, when a rotary kiln furnace having a furnace inner volume of about 40 L is used, the gas flow rate (purge amount) can be, for example, about 10 to 15 L/min.

Regarding the heat treatment furnace that can be used in Step (q), in addition to the vacuum purge tube furnace, various heat treatment furnaces, for example, a rotary kiln type, a roller hearth kiln type, a batch kiln type, a pusher kiln type, a mesh belt kiln type, a carbon furnace, a tunnel kiln type, a shuttle kiln type, a lifting truck kiln type, may be used. These heat treatment furnaces may be used alone or two or more thereof may be used in combination. Here, when two or more thereof are combined, heat treatment furnaces may be connected in series or parallel.

The method of producing a SiOC structure of the disclosure may further include an additional step of crushing and/or classifying the SiOC structure obtained by the heat treatment in Step (q). The crushing method and classification method that can be used in this step are not particularly limited, and for example, various known methods may be used, and a mortar, various crushers, a sieve, a cyclone classification device, and the like can be used.

The method of producing a SiOC structure of the disclosure may further include steps included in the method of producing a silicon nanoparticle/silicon-containing polymer composite of the disclosure. The steps that can be included in the method of producing a silicon nanoparticle/silicon-containing polymer composite are as described above. Embodiments of the method of producing a SiOC structure including these steps are also clearly disclosed in this specification.

### Negative Electrode Composition and Method of Producing the Same

According to still another aspect of the disclosure, a negative electrode composition is disclosed. The negative electrode composition includes the SiOC structure as a negative electrode active material. In addition, according to yet another aspect of the disclosure, a method of producing the negative electrode composition is disclosed. The method of producing the negative electrode composition includes obtaining a negative electrode composition using the SiOC structure as a negative electrode active material.

The negative electrode composition according to the disclosure may further include additional components such as a carbon-based conductive additive and/or a binder, which will be described below.

Preferable specific examples of a carbonaceous material that functions as a carbon-based conductive additive include carbonaceous materials such as graphite, carbon black, fullerene, carbon nanotubes, carbon nanofoams, pitch-based carbon fibers, polyacrylonitrile carbon fibers, and amorphous carbon. These carbonaceous materials may be used alone or two or more thereof may be used in combination.

Regarding the binder used in the disclosure, any binder that can be used in a secondary battery is sufficient. For example, carboxymethyl cellulose, polyacrylic acid, alginate, glucomannan, amylose, saccharose and its derivatives and polymers, and in addition to respective alkali metal salts, polyimide resins and polyimide amide resins may be exemplified. These binders may be used alone or two or more thereof may be used in combination.

Further, in addition to the binder, for example, additives that can provide other functions for improving binding between a current collector and a negative electrode active material, improving dispersibility of the negative electrode active material, and improving conductivity of the binder itself and the like can be added as necessary. Specific examples of such additives include styrene-butadiene rubber polymers and styrene-isoprene/rubber polymers and the like.

When the negative electrode composition according to the disclosure further includes additional components such as a carbon-based conductive additive and/or a binder as described above, the method of producing a negative electrode composition according to the disclosure may include the following Step (r).

Step (r): mixing the SiOC structure of the disclosure with the additional components or combining or applying the additional components with or to the SiOC structure of the disclosure.

Specific methods that can be used to achieve Step (r) include a method in which the SiOC structure and a carbonaceous material are dispersed by a mechanical mixing method using various stirring bars, a stirring blade, mechanofusion, a ball mill, a vibration mill, or the like. Particularly, a dispersion treatment using a thin-film spin method that can be realized using a thin-film spin system high-speed mixer [FILMIX (registered trademark) series, commercially available from PRIMIX Corporation] or the like is preferably used. In the method of producing a negative electrode composition according to the disclosure, these mechanical mixing methods and dispersion methods may be used alone to obtain a negative electrode composition, and a negative electrode composition may be obtained by combining a plurality of methods step by step.

For example, in Step (r), predetermined amounts of the SiOC structure of the disclosure and optional carbon-based conductive additives are added to a binder aqueous solution having a concentration of about 1 to 5 weight %, and mixed using a stirring bar, other mixers, or the like. In addition, water is additionally added to the obtained mixture as necessary so that a predetermined solid content concentration is achieved, and stirring additionally continues to obtain a slurry-like composition, which may be used as a negative electrode composition of the disclosure. In addition, a composition obtained by performing a dispersion treatment on the slurry-like composition using the above thin-film spin method may be used as a negative electrode composition of the disclosure.

In addition, in the optional Step (r), appropriately, the SiOC structure and a carbonaceous material may be mixed at arbitrary proportions according to the purpose or to obtain desired battery characteristics.

Here, the method of producing a negative electrode composition according to the disclosure may optionally include, before the above step, steps that can be included in the method of producing the SiOC structure, and embodiments including those optional steps are also clearly disclosed in this specification.

### Negative Electrode and Method of Producing the Same

According to yet another aspect of the disclosure, a negative electrode is disclosed.

In addition, according to yet another aspect of the disclosure, a method of producing a negative electrode is also disclosed, and a negative electrode of the disclosure is obtained by the method of producing a negative electrode. The method includes obtaining a negative electrode using the SiOC structure or the negative electrode composition.

Examples of specific production steps will be described below.

The negative electrode of the disclosure is specifically produced using the SiOC structure as the negative electrode active material or the negative electrode composition including the SiOC structure as a negative electrode active material.

More specifically, for example, the negative electrode may be produced based on a method of molding the SiOC structure or the negative electrode composition into a certain shape or a method of applying the SiOC structure or the negative electrode composition to a current collector such as a copper foil. The method of molding a negative electrode is not particularly limited and any method may be used, and various known methods may be used.

More specifically, for example, a negative electrode composition prepared in advance may be directly applied to a rod-like, plate-like, foil-like, or mesh-like current collector mainly composed of copper, nickel, stainless steel or the like using a method such as a doctor blade method, a slurry casting method, a screen printing method, or the like. Alternatively, the negative electrode composition is separately cast on a support, a negative electrode composition film formed on the support is peeled off, and the peeled off negative electrode composition film may be laminated on the current collector to form a negative electrode plate.

In addition, an air-drying process or a drying process step at a predetermined temperature is performed on the negative electrode composition applied to the current collector or the support and/or additionally a processing process step according to a pressing process, a punching process, or the like as necessary is performed and thus a final negative electrode may be obtained.

Here, the method of producing a negative electrode according to the disclosure may optionally include, before the above step, steps that can be included in the method of producing a SiOC structure and the method of producing a negative electrode composition, and these embodiments are also clearly disclosed in this specification. In addition, the form of the negative electrode is only an example, and the form of the negative electrode is not limited thereto and it should be noted that the negative electrode can be provided in other forms.

### Secondary Battery and Method of Producing the Same

According to yet another aspect of the disclosure, a secondary battery is provided.

In addition, according to yet another aspect of the disclosure, a method of producing a secondary battery is provided. The method includes producing a secondary battery using the above negative electrode.

The secondary battery of the disclosure includes at least one negative electrode of the disclosure. The secondary battery of the disclosure includes at least one negative electrode of the disclosure, and as long as it functions as a secondary battery, other constituent components and structures are not particularly limited, and more specifically, the secondary battery includes at least one positive electrode and at least one separator in addition to the negative electrode. When the secondary battery of the disclosure includes a plurality of negative electrodes of the disclosure, and positive electrodes and separators, a lamination-type laminated structure in which these constituent components are alternately laminated in the order of positive electrode/separator/negative electrode/separator may be used. Alternatively, a laminated structure in which a positive electrode and a negative electrode are wound in a coil shape with a separator therebetween may be used. In addition, the secondary battery of the disclosure may contain an electrolytic solution or a solid electrolyte.

The secondary battery according to the disclosure is specifically a secondary battery obtained by the method of producing a secondary battery according to the disclosure. The secondary battery may be appropriately designed in consideration of desired applications and functions and the like, and its configuration is not particularly limited, and with reference to the configuration of an existing secondary battery, a secondary battery can be configured using the negative electrode according to the disclosure. In addition, the type of the secondary battery of the disclosure is not particularly limited as long as the negative electrode can be applied, and for example, a lithium ion secondary battery and a lithium ion polymer secondary battery may be exemplified. These batteries can be said to be particularly preferable embodiments because desired effects of the disclosure can be exhibited as demonstrated in the following examples.

Hereinafter, embodiments in which a secondary battery and a method of producing the same according to the disclosure are particularly exemplified for a lithium ion secondary battery will be described.

First, a positive electrode active material composition in which a positive electrode active material that can reversibly store and release lithium ions, a conductive additive, a binder and a solvent are mixed is prepared. The positive electrode active material composition is directly applied to a metal current collector and dried using various methods in the same manner as in the negative electrode to prepare a positive electrode plate. The positive electrode active material composition is separately cast on a support, a film formed on the support is peeled off, and the film can be laminated on a metal current collector to produce a positive electrode. The method of molding a positive electrode is not particularly limited, but can be formed using various known methods.

Regarding the positive electrode active material, a lithium metal composite oxide that is generally used in the field of the secondary battery can be used. Examples thereof include lithium cobaltate, lithium nickelate, a lithium manganate having a spinel structure, cobalt lithium manganate, an iron phosphate having an olivine structure, a so-called ternary lithium metal composite oxide, and a nickel-based lithium metal composite oxide. In addition, V₂O₅, TiS and MoS which are compounds that can remove and insert lithium ions can be used.

A conductive additive may be added, and those that are generally used in lithium ion batteries can be used. An electron conductive material that does not cause decomposition or deterioration in the produced battery is preferable. Specific examples include carbon black (acetylene black, etc.), graphite fine particles, vapor-grown carbon fibers, and combinations of two or more thereof. In addition, examples of binders include vinylidene fluoride/propylene hexafluoride copolymers, polyvinylidene fluoride (PVDF), polyacrylonitrile, polymethylmethacrylate, polytetrafluoroethylene and mixtures thereof, and styrene butadiene rubber polymers, but the disclosure is not limited thereto. In addition, examples of solvents include N-methylpyrrolidone, acetone, and water, but the disclosure is not limited thereto.

In this case, the contents of the positive electrode active material, the conductive additive, the binder, and the solvent are not particularly limited, and can be appropriately selected based on amounts thereof generally used in lithium ion batteries as a guide.

Regarding the separator interposed between the positive electrode and the negative electrode, any separator that is generally used in lithium ion batteries may be used without particular limitation, and the separator may be appropriately selected in consideration of desired applications and functions and the like. Those having a low resistance to ion transfer of an electrolyte or having an excellent electrolytic solution impregnation ability are preferable. Specifically, a material which is selected from among glass fibers, polyester, polyethylene, polypropylene, polytetrafluoroethylene, polyimide, and compounds thereof and in the form of non-woven fabric or woven fabric may be used. More specifically, preferably, a windable separator made of a material such as polyethylene and polypropylene is used in lithium ion batteries, and a separator having an excellent organic electrolytic solution impregnation ability is used in lithium ion polymer batteries.

Regarding the electrolytic solution, those in which, in a solvent such as propylene carbonate, ethylene carbonate, dimethyl carbonate, diethyl carbonate, ethylmethyl carbonate, methylpropyl carbonate, butylene carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene or diethyl ether, or a solvent mixture thereof, one of electrolytes composed of lithium salts such as lithium hexafluoro phosphate, lithium tetrafluoroborate, lithium hexafluoroantimonate, lithium hexafluoroarsenate, lithium perchlorate, lithium trifluoromethanesulfonate, Li(CF₃SO₂)₂N, LiC₄F₉SO₃, LiSbF₆, LiAlO₄, LiAlCl₄, LiN(CₓF₂ₓ₊₁SO₂)(C_{y}F_{2y+1}SO₂) (provided that x and y are a natural number), LiCl, and LiI or a mixture of two or more thereof is dissolved can be used.

In addition, various non-aqueous electrolytes and solid electrolytes can be used in place of the electrolytic solution. For example, various ionic liquids to which lithium ions are added, a pseudo solid electrolyte in which an ionic liquid and fine powder are mixed, a lithium ion conductive solid electrolyte, and the like can be used.

In addition, in order to improve charging and discharging cycle characteristics, the electrolytic solution can appropriately contain a compound that promotes stable film formation on the surface of the negative electrode active material. For example, vinylene carbonate (VC), fluorobenzene, and fluorinated carbonates such as cyclic fluorinated carbonate [fluoroethylene carbonate (FEC), trifluoropropylene carbonate (TFPC), etc.] and chain fluorinated carbonate [trifluorodimethyl carbonate (TFDMC), trifluorodiethyl carbonate (TFDEC), trifluoroethyl methyl carbonate (TFEMC), etc.] are effective. Here, the cyclic fluorinated carbonate and chain fluorinated carbonate can be used as a solvent like ethylene carbonate.

A battery structure is formed by inserting a separator between the positive electrode plate and the negative electrode plate as described above, the battery structure is wound or folded and put into a cylindrical battery case or a rectangular battery case, and an electrolytic solution may be then injected to complete a lithium ion battery. Alternatively, the battery structure is laminated in a bicell structure and then impregnated with an organic electrolytic solution, the obtained product is put into a pouch, the pouch is sealed, and thereby a lithium ion polymer battery may be obtained as the secondary battery of the disclosure.

Here, the method of producing a secondary battery according to the disclosure may further include, before the above step, steps included in the method of producing a SiOC structure, the method of producing a negative electrode composition, and the method of producing a negative electrode.

Hereinafter, examples and comparative examples will be shown and the disclosure will be described in more detail, but the disclosure is not limited to these examples.

### EXAMPLES

Various analyses and evaluations were performed on materials produced in examples and comparative examples.

First, methods for various analyses and evaluations will be described below.

Here, hereinafter, Ph represents a phenyl group, and Me represents a methyl group.

### Observation Under Scanning Electron Microscope (SEM)

The materials produced in examples and comparative examples were observed under an SEM.

Regarding the SEM, an ultra-high resolution analytical scanning electron microscope SU-70 (commercially available from Hitachi High-Technologies Corporation) and a 3D real surface view microscope VE-9800 (commercially available from Keyence Corporation) were used, and measurement and observation were performed at an arbitrary acceleration voltage.

### Transmission Electron Micxroscope (TEM) Image

Regarding the TEM, a field emission transmission analysis electron microscope TecnaiG2F20 (commercially available from FEI) was used, and measurement and observation were performed at an arbitrary acceleration voltage.

### Measurement of Particle Size Distribution

In the following Examples 1, 2 and 4, the particle size distribution of the synthesized silicon nanoparticle/methyl polysilsesquioxane composite was measured. In addition, the particle size distribution of the SiOC structure produced in Examples 1 and 2 was measured. The method of measuring a particle size distribution is as follows. A small amount of the prepared silicon nanoparticle/methyl polysilsesquioxane composite or SiOC structure was put into a beaker, a few drops of water and a 0.5% Triton X-100 aqueous solution were added thereto, and the mixture was subjected to a dispersion treatment using Ultrasonic Homogenizer US-150 (commercially available from Nissei Corporation) for 3 minutes to prepare a measurement sample. The measurement sample was measured using a laser diffraction scattering type particle size distribution measuring device MT3300II (commercially available from MicrotracBel Corp.).

### Evaluation of Battery Characteristics

Negative electrode active materials containing the materials produced in the examples and comparative examples were prepared, and negative electrodes using the negative electrode active materials and lithium ion secondary batteries were subjected to the following charging and discharging cycle test to evaluate battery characteristics. Hereinafter, procedures thereof will be shown. Using HJR-110mSM, HJ1001SM8A or HJ1010mSM8A (commercially available from Hokuto Denko Corporation), for both charging and discharging, measurement was performed at a constant current. In this case, a current value of 0.05 C was used so that the capacity was 1/20 of the theoretical capacity per 1 g of the negative electrode active material (SiOC particles). In addition, charging was performed until the battery voltage was lowered to 0 V and discharging was performed until the battery voltage reached 1.5 V. During switching between charging and discharging, after pausing an open circuit for 30 minutes, discharging was performed.

In the above conditions, a charging and discharging cycle was repeated 50 times, and various battery characteristics were measured.

### Example 1

### Synthesis According to Mixing Ratio of about 80 mL of Acetic Acid Solution/1 g of Silicon Nanoparticles

### Preparation of Silicon Nanoparticle/Methyl Polysilsesquioxane Composite

800 g of a 0.001 M acetic acid aqueous solution, 8 g of Tween 80, and 10 g of silicon nano powder (commercially available from Sigma Aldrich; with a volume-based average particle size of less than 100 nm; here, the particle size exceeded 10 nm.) were put into a beaker, and a silicon nanoparticle dispersion solution was prepared using an ultrasonic washing machine. The obtained silicon nanoparticle dispersion solution was put into a 1 L three-neck flask, 24.3 g (178 mmol) of methyltrimethoxysilane (commercially available from Tokyo Chemical Industry Co., Ltd.) was added dropwise thereto at room temperature while stirring, and then reacted for 30 minutes. 1.3 g of ammonia water with a concentration of 28 mass % was added dropwise to the mixture solution obtained in this manner and stirred at room temperature for 2 hours. The obtained reaction product was filtered through a membrane filter (with a pore size of 0.45 μm, hydrophilic), and a solid was collected. The obtained solid was dried under a reduced pressure at 80° C. for 10 hours, and thereby 20.7 g of silicon nanoparticle/methyl polysilsesquioxane composite (1) powder was obtained.

Here, immediately before the ammonia water was added, and 2 hours after the ammonia water was added, a part of the sample was subjected to measurement of a particle size distribution.

In addition, in this example, from the calculation, the pH value during the hydrolysis reaction was found to be 3.78. In addition, from the same calculation, the pH value during the polycondensation reaction was found to be 10.7.

### Preparation of SiOC Structure

21.9 g of the silicon nanoparticle/methyl polysilsesquioxane composite (1) powder was placed on a SSA-S grade alumina boat, the boat was then set in a vacuum purge tube furnace KTF43N1-VPS (commercially available from Koyo Thermo Systems Co., Ltd.), and regarding heat treatment conditions, under an argon gas atmosphere (high purity argon gas of 99.999%), argon gas was supplied at a flow rate of 250 ml/min, the temperature was raised at a rate of 4° C./min, burning was performed at 1,200° C. for 5 hours, and thereby a burned product of the silicon nanoparticle/methyl polysilsesquioxane composite was obtained.

Next, the burned product obtained in this manner was pulverized and ground in a mortar for 5 minutes, and classified using a stainless steel sieve with openings of 32 μm, and thereby 17.6 g of silicon nanoparticle/methyl polysilsesquioxane composite burned product powder [SiOC structure (1)] having a maximum particle size of 32 μm was obtained.

Here, a part of the SiOC structure (1) obtained in this manner was subjected to observation under an SEM, observation under a TEM, and measurement of a particle size distribution.

### Production of Negative Electrode Compositoin and Negative Electrode

3.2 g of the SiOC structure (1) powder and 0.4 g of acetylene black (commercially available from Denka Co., Ltd.) were added to 20 g of an aqueous solution containing 2 weight% of carboxymethyl cellulose, and mixed in a flask using a stirrer for 15 minutes, and distilled water was then added so that the concentration of the solid content became 15 weight %, and stirring was additionally performed for 15 minutes, and thereby a slurry-like composition was prepared. The slurry-like composition was transferred to a thin-film spin system high-speed mixer (FILMIX40-40 type, commercially available from Primix Corporation), and stirring and dispersion were performed at a rotational speed of 20 m/s for 30 seconds. The slurry after the dispersion treatment was applied onto a copper foil roller according to a doctor blade method so that the thickness of the slurry was 150 μm.

After air-drying for 30 minutes after application, drying was performed on a hot plate at 80° C. for 90 minutes. After drying, a negative electrode sheet was pressed by a 2t small precision roll press (commercially available from Thank Metal Co., Ltd.). After pressing, the electrode was punched out using a φ14.50 mm electrode punching tool HSNG-EP, drying was performed under a reduced pressure in a glass tube oven GTO-200 (SIBATA) at 80° C. for 12 hours or longer, and thereby a negative electrode was produced.

### Production and Evaluation of Lithium Ion Secondary Battery

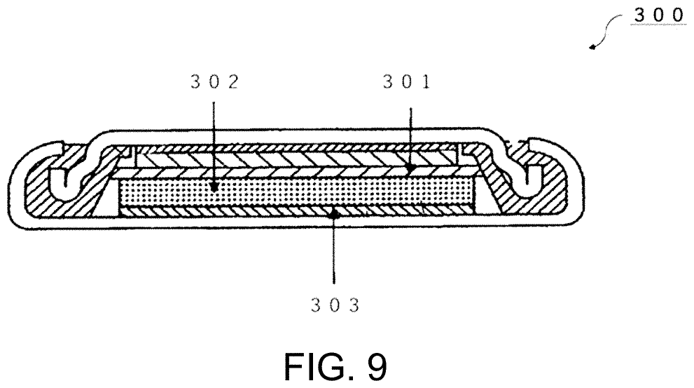

A 2032 type coin cell 300 having a structure shown in FIG. 9 was produced as a lithium ion secondary battery. Metallic lithium was used for a positive electrode (lithium counter electrode) 303, a microporous polypropylene film was used as a separator 302, the negative electrode was used as a negative electrode(negative electrode material) 301, and a solvent in which LiPF₆ was dissolved at a proportion of 1 mol/L as an electrolytic solution and ethylene carbonate and diethyl carbonate were mixed at 1:1 (volume ratio) was used.

Next, battery characteristics of the lithium ion secondary battery were evaluated. HJ1001SM8A (commercially available from Hokuto Denko Corporation) was used as a charging and discharging tester. In charging and discharging conditions, both charging and discharging were performed at a constant current of 0.05 C, a discharge end voltage was set to 1 mV, and a charge end voltage was set to 1,500 mV.

### Example 2

### Synthesis According to Mixing Ratio of about 40 mL of Acetic Acid Solution/1 g of Silicon Nanoparticles

A silicon nanoparticle/methyl polysilsesquioxane composite (2) and its burned product [SiOC structure (2)] were obtained in the same procedures as in Example 1 except that, in the step of preparing a silicon nanoparticle/methyl polysilsesquioxane composite in Example 1, the amount of a 0.001 M acetic acid aqueous solution was changed to 400 g, and the amount of Tween 80 was changed to 4 g.

Here, when the silicon nanoparticle/methyl polysilsesquioxane composite (2) was synthesized, immediately before ammonia water was added, 2 hours after the ammonia water was added, a part of the sample was subjected to measurement of a particle size distribution. In addition, a part of the obtained SiOC structure (2) was subjected to observation under a SEM, observation under a TEM, and measurement of a particle size distribution. In addition, a negative electrode composition, a negative electrode, and a lithium ion secondary battery were produced in the same manner as in Example 1 except that the SiOC structure (2) obtained in this example was used in place of the SiOC structure (1) in Example 1, and battery characteristics were evaluated.

### Example 3

A silicon nanoparticle/methyl polysilsesquioxane composite (3) and its burned product [SiOC structure (3)] were obtained in the same procedures as in Example 1 except that, in the step of preparing a silicon nanoparticle/methyl polysilsesquioxane composite in Example 1, only the amount of Tween 80 was changed to a half (final concentration 0.5%) with respect to Example 1 (final concentration 1%).

### Example 4

A silicon nanoparticle/methyl polysilsesquioxane composite (4) and its burned product [SiOC structure (4)] were obtained in the same procedures as in Example 2 except that, in the step of preparing a silicon nanoparticle/methyl polysilsesquioxane composite in Example 2, a dilute acetic acid with a low acetic acid concentration was used as a hydrolysis catalyst, methyltrimethoxysilane was added dropwise at a temperature of 25° C. or lower to promote hydrolysis, and then 11.3 g of 3% ammonia water with a low ammonia concentration was added dropwise thereto over 2 hours until the pH of the reaction solution became 8, and thus polycondensation was performed.

### Comparative Example 1

### MeSiO_{0.5}

3.6 g of water, 7 g of isopropanol and 4.12 g of silicon nano powder (Sigma Aldrich, less than 100 nm (volume-based average particle size, but exceeding 10 nm)) were put into a beaker, and a silicon nanoparticle dispersion solution was prepared using an ultrasonic washing machine. 10.0 g of methyltrimethoxysilane was added to the dispersion solution, 0.1 g of 1 M hydrochloric acid was then added thereto, and the mixture was stirred for 30 minutes. The reaction solution was put into a thermostatic chamber at 80° C. and left overnight, and thereby a silicon nanoparticle/methyl polysilsesquioxane composite (5) in a bulk gel form was produced.

The obtained silicon nanoparticle/methyl polysilsesquioxane composite (5) was placed on a SSA-S grade alumina boat, the boat was then set in a vacuum purge tube furnace KTF43N1-VPS (commercially available from Koyo Thermo Systems Co., Ltd.), and regarding heat treatment conditions, under an argon gas atmosphere (high purity argon gas 99.999%), argon gas was supplied at a flow rate of 250 ml/min, the temperature was raised at a ratio of 4° C./min, burning was performed at 1,200° C. for 5 hours, and thereby a burned product of the silicon nanoparticle/methyl polysilsesquioxane composite (5) was prepared.

Next, the burned product of the silicon nanoparticle/methyl polysilsesquioxane composite (5) obtained as described above was ground in a mortar and classified using a stainless steel sieve with openings of 32 μm, and thereby 7.2 g of the burned product powder [SiOC composite material (5)] having a maximum particle size of 32 μm was obtained.

A part of the SiOC composite material (5) obtained in this manner was subjected to observation under an SEM as in Example 1.

In addition, a negative electrode composition, a negative electrode, and a lithium ion secondary battery were produced in the same manner as in Example 1 except that the SiOC composite material (5) obtained in this comparative example was used in place of the SiOC structure (1) in Example 1, and battery characteristics were evaluated.

### Comparative Example 2

### MeSiO_{0.5}

A silicon nanoparticle/methyl polysilsesquioxane composite (6) and its burned product [SiOC composite material (6)] were obtained in the same procedures as in Example 2 except that, in the step of preparing a silicon nanoparticle/methyl polysilsesquioxane composite in Example 2, Tween 80 as a dispersant was not added.

In addition, a part of the SiOC composite material (6) was subjected to observation under an SEM as in Example 1.

### Results

### Obsveration Under Electron Microscope

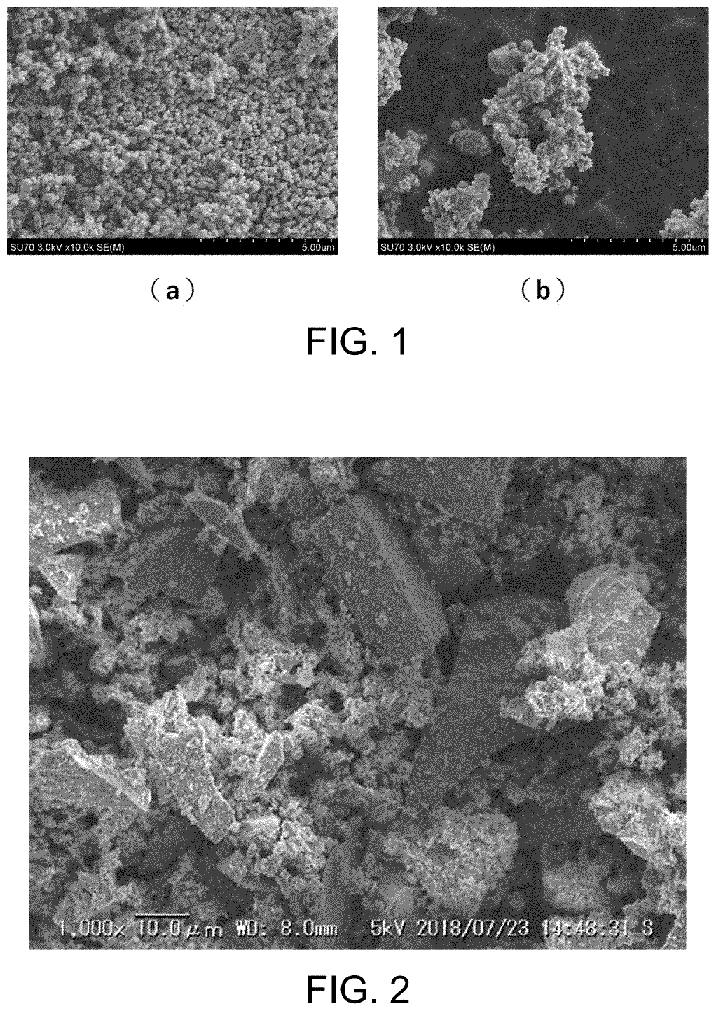

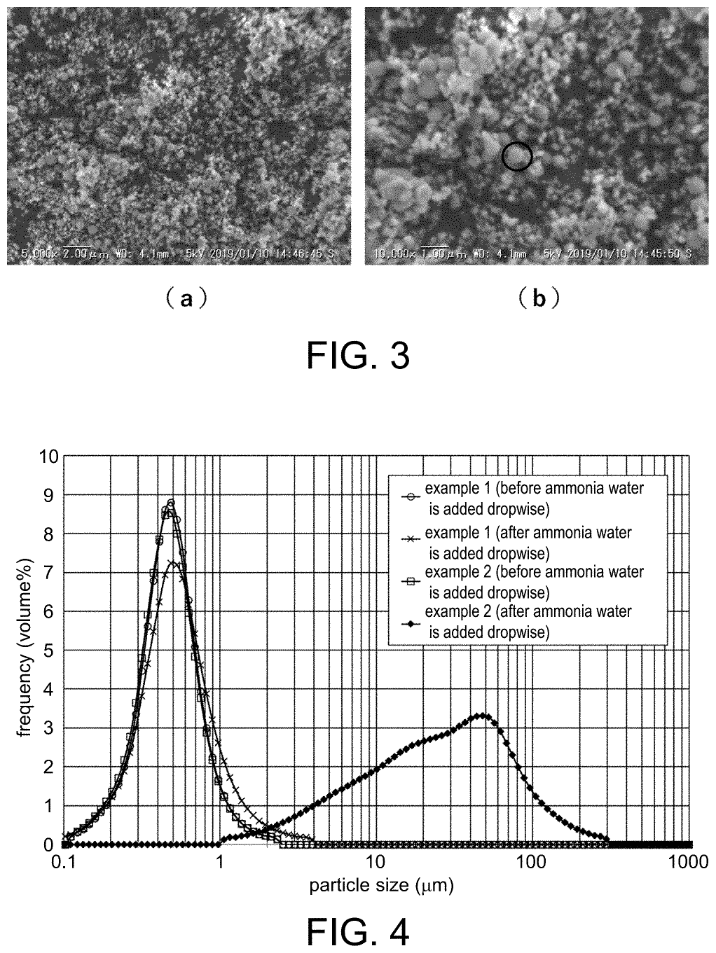

(a) and (b) of FIG. 1 show SEM images (with a magnification of 10,000) of the SiOC structures (1) and (2) produced in Examples 1 and 2. In addition, FIG. 2 shows the SEM image (with a magnification of 1,000) of the SiOC composite material (5) produced in Comparative Example 1. In addition, (a) and (b) of FIG.3 show SEM images of the SiOC composite material (6) produced in Comparative Example 3. Here, (a) of FIG. 3 shows the image with a magnification of 5,000, and (b) of FIG. 3 shows the image with a magnification of 10,000.

As can be understood from the SEM images shown in (a) and (b) of FIG. 1, it was confirmed that, in both the SiOC structures (1) and (2) produced in Examples 1 and 2, silicon nanoparticles were not exposed to the outside from the structure, but covered with a SiOC coating layer derived from a polysilsesquioxane.

In contrast to Examples 1 and 2, in the SiOC composite material (5) produced in Comparative Example 1, as can be understood from the SEM image in FIG. 2, a state in which silicon nanoparticles were covered with a SiOC coating layer derived from the polysilsesquioxane was not observed, and a large number of silicon nanoparticles with many parts exposed to the outside were confirmed. That is, in the SiOC composite material (5) produced in Comparative Example 1, a structure in which silicon nanoparticles were not uniformly covered with a SiOC coating layer, but aggregated randomly with each other was confirmed.

Incidentally, in Example 1 and Example 2, only the amount of the solvent used (0.001 M acetic acid aqueous solution) was changed, the other raw materials and amounts used thereof, and reaction conditions were the same.

Here, in Example 2 in which a silicon nanoparticle/methyl polysilsesquioxane composite was synthesized using a half amount of the solvent with respect to the amount of the solvent in Example 1, as confirmed in the SEM image in (b) of FIG. 1, an aggregated structure speculated to have formed during synthesis of polysilsesquioxane was confirmed. On the other hand, in Example 1 in which twice the amount of the solvent was used compared to Example 2, as shown in the SEM image in (a) of FIG. 1, a structure in which particles with a relatively uniform size were collected was observed. These particles were considered to be secondary particles formed by coating silicon nanoparticles with a polysilsesquioxane layer. That is, it was considered that the secondary particles were obtained when silicon nanoparticles were covered with a SioC ceramic layer derived from a polysilsesquioxane layer. In addition, as a point that should be particularly noteworthy in Example 1, the aggregated structure (the SEM image in (b) of FIG. 1) confirmed in Example 2 was not confirmed.

It was found that, when the amount of the solvent used was appropriately adjusted with respect to the reaction material in this manner, it was possible to obtain a SiOC structure having a desired form. Generally, a trend in which when the amount of the solvent was excessively small with respect to the reaction material, an aggregated structure was produced, and when the amount of the solvent was an appropriate amount, no aggregated structure was produced, and particles with a uniform size were produced was found.

As described above, in the examples according to the disclosure, it was shown that it was possible to produce a SiOC structure in which silicon nanoparticles were covered with a

SiOC coating layer derived from a polysilsesquioxane.

In addition, in order to determine the influence resulting from adding or not adding a dispersant, as described above, as Comparative Example 2, a silicon nanoparticle/polysilsesquioxane composite and a SiOC composite material were prepared without adding Tween 80 corresponding to the dispersant.

When the SiOC composite material (6) produced in Comparative Example 2 was observed under an SEM, as shown in (a) and (b) of FIG. 3, a plurality of particles with a relatively high sphericity (particles surrounded by a circle in (b) of FIG. 3) and amorphous particles having a smaller size than those particles were confirmed. Here, the plurality of particles with a relatively high sphericity were derived from a polymer produced by polymerizing only methyltrimethoxysilane in a phase-separated state, and amorphous fine particles with a smaller size were assumed to be silicon nanoparticles. That is, in Comparative Example 2 in which a silicon nanoparticle/polysilsesquioxane composite was synthesized without addition of the dispersant, a structure form in which silicon nanoparticles were covered with a SiOC composite layer as observed in Example 1 and Example 2 was not observed.

Next, FIG. 4 shows a graph of particle size distributions obtained by measuring particle size distributions of the silicon nanoparticle/methyl polysilsesquioxane composites (1) and (2) synthesized in Examples 1 and 2. That is, the silicon nanoparticle/methyl polysilsesquioxane composites (1) and (2) corresponded to the samples before burning.

FIG. 4 shows particle size distributions before and after ammonia water with a concentration of 28 mass % was added for the polycondensation reaction after the hydrolysis reaction of the predetermined silane compound in Examples 1 and 2. In addition, in the particle size distribution before and after ammonia water with a concentration of 28 mass % was added, a volume-based average particle size, a cumulative 10% particle size (D10), a cumulative 50% particle size (D50, so-called median size), and a cumulative 90% particle size (D90) were calculated. The values of these particle sizes are shown in Table 1.

TABLE 1

| | Volume-based | | | | |
|---|---|---|---|---|---|
| | average particle | D10 | D50 | D90 | D90/D10 |
| | size (μm) | (μm) | (μm) | (μm) | ratio |
| Example 1 (before | 0.53 | 0.25 | 0.46 | 0.79 | 3.2 |
| ammonia is added | | | | | |
| dropwise) | | | | | |
| Example 1 (after | 0.63 | 0.25 | 0.49 | 1.02 | 4.1 |
| ammonia is added | | | | | |
| dropwise) | | | | | |
| Example 2 (before | 0.52 | 0.25 | 0.45 | 0.79 | 3.2 |
| ammonia is added | | | | | |
| dropwise) | | | | | |
| Example 2 (after | 39.04 | 4.71 | 25.01 | 82.77 | 17.6 |
| ammonia is added | | | | | |
| dropwise) | | | | | |

In Example 1, also in the sample after polycondensation according to addition of ammonia water was completed, the peak of the particle size distribution was sharp, and the sample was composed of particles with a relatively uniform size. On the other hand, in Example 2, in the sample after polycondensation according to addition of ammonia water was completed, the particle size was considerably large, and the particle size distribution was also broad. Results obtained by measuring the particle size distribution corresponded to particle forms observed in the SEM images in (a) and (b) of FIG. 1. That is, the results of the particle size distribution provided that, in the SEM image in (a) of FIG. 1 according to Example 1, secondary particles formed by coating silicon nanoparticles with a SiOC coating layer also had a uniform size, and an aggregated structure and the like were not confirmed, and on the other hand, in the SEM image in (b) of FIG. 1 according to Example 2, covering of silicon nanoparticles with a SiOC coating layer was confirmed, but production of an aggregated structure with secondary particles was observed.

Based on the results of Examples 1 and 2, it was speculated that, when the amount of the solvent was small, after ammonia water was added dropwise, relatively rapid polycondensation of the silane compound partially proceeded, and as a result, the aggregated structure was produced.

In addition, in Example 3, only the amount of Tween 80 was changed to a half amount (final concentration 0.5%) with respect to Example 1 (final concentration 1%), but the inventors have confirmed formation of the same aggregated structure as in Example 2 (SEM image and the like are not shown). In addition, as described above, in Comparative Example 2 in which a silicon nanoparticle/polysilsesquioxane composite was synthesized without addition of Tween 80 as the dispersant, only the silane compound was polymerized in a phase-separated state, and a structure in which silicon nanoparticles were covered with a SiOC composite layer as observed in Example 1 and Example 2 was not formed (FIG. 3).

Based on the results of Example 3 and Comparative Example 2, it was understood that a structure in which silicon-based fine particles were covered with a SiOC coating layer was exhibited and not only the amount of the solvent but also the amount of Tween 80 as the dispersant were important. Based on the results of Example 2 and Comparative Example 2, it was thought that Tween 80 functioned as a phase separation inhibitor in the reaction system, and inhibited phase separation of oligomers that were produced in the polycondensation reaction, and thus inhibited production of aggregation.

In addition, in Example 4, based on conditions in Example 2, a dilute acetic acid having a low acetic acid concentration was used as a hydrolysis catalyst, methyltrimethoxysilane was added dropwise thereof at a temperature of 25° C. or lower to promote hydrolysis, and 3% ammonia water having a low ammonia concentration was then slowly added dropwise thereto until the pH of the reaction solution became 8, and thus polycondensation was performed.

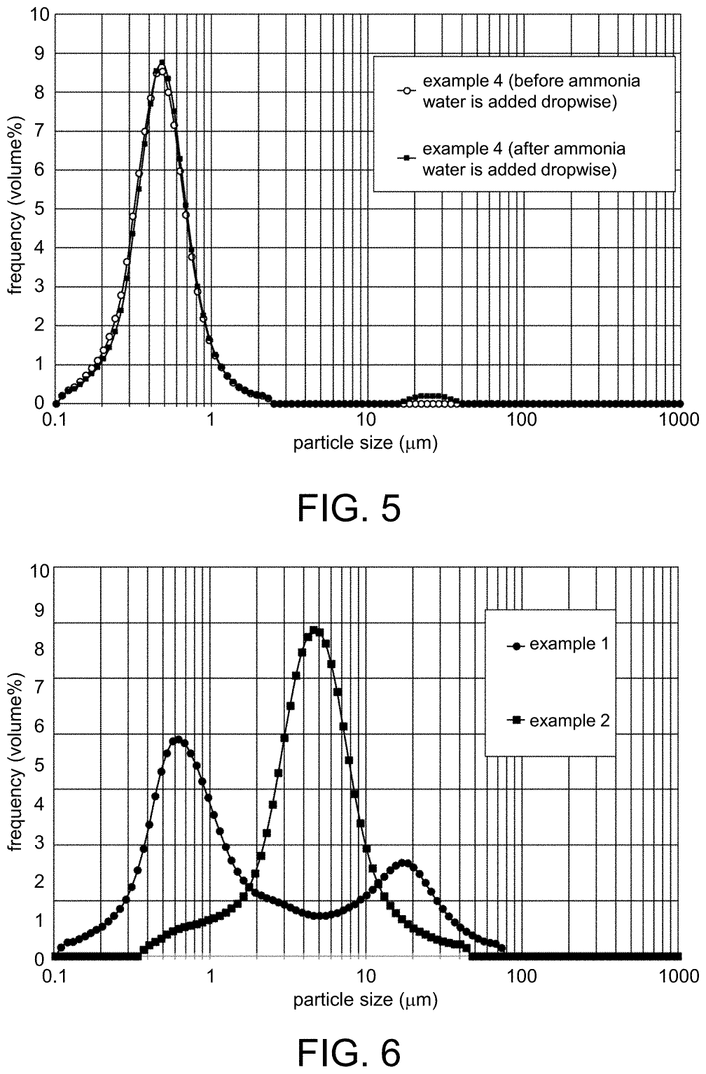

FIG. 5 shows particle size distributions before and after ammonia water with a concentration of 28 mass % for the polycondensation reaction was added after the predetermined silane compound was subjected to the hydrolysis reaction in Example 4. In addition, in Example 4, the particle size distributions before and after ammonia water with a concentration of 28 mass % was added, a volume-based average particle size, a cumulative 10% particle size (D10), a cumulative 50% particle size (D50, so-called median size), and a cumulative 90% particle size (D90) were calculated. The values of these particle sizes are shown in Table 2.

TABLE 2

| | Volume-based | | | | |
|---|---|---|---|---|---|
| | average particle | D10 | D50 | D90 | D90/D10 |
| | size (μm) | (μm) | (μm) | (μm) | ratio |
| Example 4 (before | 0.52 | 0.25 | 0.45 | 0.79 | 3.2 |
| ammonia water is | | | | | |
| added dropwise) | | | | | |
| Example 4 (after | 0.90 | 0.26 | 0.46 | 0.83 | 3.2 |
| ammonia water is | | | | | |
| added dropwise) | | | | | |

In the results, as shown in FIG. 5, in Example 4, it was confirmed that, even after ammonia water was added dropwise, the peak of the particle size distribution was sharp, and a silicon nanoparticle/methyl polysilsesquioxane composite composed of particles with a uniform size was produced. It was clearly understood that, when the concentration of the catalyst (acid and base) solution added in the hydrolysis and polycondensation in this manner, the reaction temperature, and the method of adding a catalyst (particularly the base) to the reaction solution were appropriately selected and adjusted, it was possible to appropriately control the particle size and shape of the produced composite/SiOC structure and production of an aggregate.

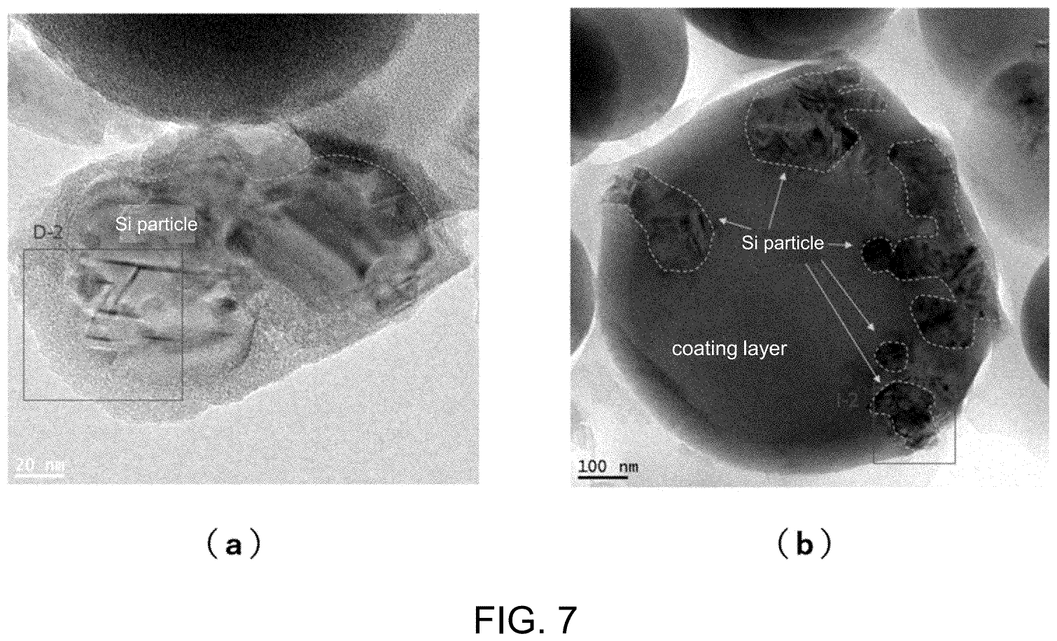

Next, results obtained by measuring the particle size distribution of the SiOC structures (1) and (2) obtained in Examples 1 and 2 are shown in FIG. 6. In addition, a volume-based average particle size, a cumulative 10% particle size (D10), a cumulative 50% particle size (D50, so-called median size), and a cumulative 90% particle size (D90) of the SiOC structures (1) and (2) were calculated. The values of these particle sizes are shown in Table 3. Here, Table 3 shows various particle sizes before and after ammonia water was added dropwise when the silicon nanoparticle/polysilsesquioxane composite was synthesized.

TABLE 3

| | Volume-based | | | | |
|---|---|---|---|---|---|
| | average particle | D10 | D50 | D90 | D90/D10 |
| | size (μm) | (μm) | (μm) | (μm) | ratio |
| Example 1 (after | 0.63 | 0.25 | 0.49 | 1.02 | 4.1 |
| ammonia water is | | | | | |
| added dropwise) | | | | | |
| Example 1 SiOC | 6.49 | 0.36 | 1.05 | 19.84 | 55.1 |
| structure (1) | | | | | |
| Example 2 (after | 39.04 | 4.71 | 25.01 | 82.77 | 17.6 |
| ammonia water is | | | | | |
| added dropwise) | | | | | |
| Example 2 SiOC | 5.86 | 1.60 | 4.39 | 10.07 | 6.3 |
| structure (2) | | | | | |

In the results shown in FIG. 6 and Table 3, although no corresponding particle size tendency was observed between Example 1 and Example 2, in Example 1 in which no aggregated structure was formed, it was observed that the volume-based average particle size of the SiOC structure after burning, and D10, D50 and D90 tended to be larger than those before burning.

Next, in order to analyze a detailed structure of the structure (secondary particles), the SiOC structures (1) and (2) produced in Examples 1 and 2 were observed under a TEM as described above. The results are shown in (a) and (b) of FIG. 7.

The TEM image in (a) of FIG. 7 corresponded to the sample in Example 1, and the TEM image in (b) of FIG. 7 corresponded to the sample in Example 2. In the TEM image (Example 1) in (a) of FIG. 7, it was confirmed that one silicon nanoparticle was covered with a SiOC coating layer and secondary particles were formed. On the other hand, in the TEM image (Example 2) in (b) of FIG. 7, it was confirmed that a plurality of silicon nanoparticles were covered with a SiOC coating layer and secondary particles were formed. These differences were speculated to be caused by the fact that, in Example 1 using an amount of the solvent at which phase separation could be more effectively inhibited, since the size of precipitated oligomer particles was small, only a single silicon nanoparticle was incorporated into most oligomer particles, and relatively small secondary particles without aggregation were formed. On the other hand, in Example 2 in which an effect of inhibiting phase separation was slightly inferior because the amount of the solvent was relatively small, since the size of precipitated oligomer particles was relatively large, a plurality of silicon nanoparticles were incorporated into most oligomer particles, and as a result, it was speculated that a composite or structure form in which the plurality of silicon nanoparticles were covered with a SiOC coating layer was produced.

### Results of Charging and Discharging Cycle Test

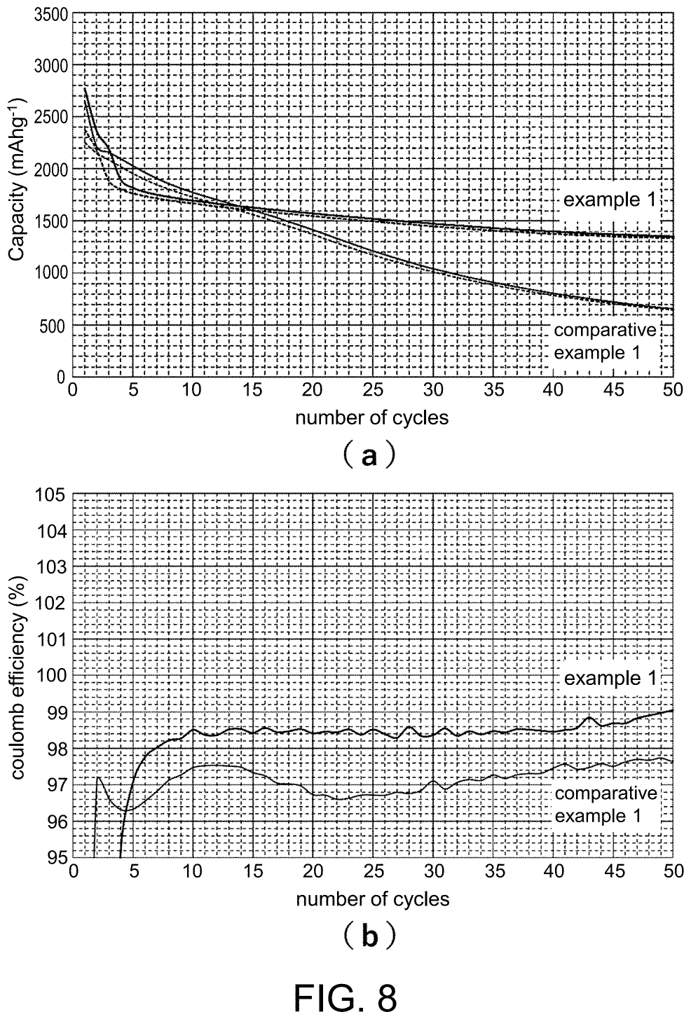

The results obtained by performing the charging and discharging cycle test on the lithium ion batteries produced in Example 1 and Comparative Example 1 are shown in Table 4 and FIG. 8.

TABLE 4

| | | Initial | Initial | | 5-50 cycle | |
|---|---|---|---|---|---|---|
| | | charging | discharging | | capacity | 5-50 cycle |
| | Type | capacity | capacity | FCE | retention rate | average CE |
| Example 1 | MeSiO_{0.5} | 2,772 | 2,377 | 85.4% | 75.8% | 98.5% |
| Comparative | MeSiO_{0.5} | 2,575 | 2,185 | 84.8% | 32.9% | 97.2% |
| Example 1 | | | | | | |

First, as can be seen from (a) and (b) of FIG. 8, since the drop in the capacity tended to be relatively stable around 5 cycles, regarding the results of this charging and discharging cycle test, the capacity retention rate at the 50th cycle with respect to the 5th cycle (5-50 cycle capacity retention rate) and the average Coulomb efficiency at the 50th cycle with respect to the 5th cycle (5-50 cycle average CE) were calculated, and thus performances of the lithium ion batteries were evaluated.

As a result, as shown in Table 4 and (a) and (b) of FIG. 8, in the lithium ion battery produced in Example 1, in the charging and discharging cycle test, the 5-50 cycle capacity retention rate had a value of 75.8% and a very good capacity retention rate was maintained. In addition, in the lithium ion battery according to Example 1, the 5-50 cycle average CE had a value of 98.5% and a very good average Coulomb efficiency was maintained.

On the other hand, in the lithium ion battery produced in Comparative Example 1, the 5-50 cycle capacity retention rate had merely a value of 32.9%, which was very inferior to that of the lithium ion secondary battery according to Example 1 using the predetermined SiOC structure of the disclosure as a negative electrode material. In addition, in the lithium ion secondary battery of Comparative Example 1, the 5-50 cycle average CE had merely a value of 97.2%, which was inferior to that of the lithium ion secondary battery of Example 1.

As described above, according to the results of the cycle test performed on the lithium ion batteries according to Example 1 and Comparative Example 1, it was found that, when the predetermined SiOC structure of the disclosure was used as a negative electrode active material, it was possible to provide a secondary battery having a high capacity retention rate and Coulomb efficiency.

The disclosure has high industrial applicability in the field of materials/chemistry for producing SiOC materials, negative electrode active materials, negative electrode materials and the like, and the field of electrical and electronics such as secondary batteries and various electronic devices.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A SiOC structure, comprising:
(A) at least one silicon-based fine particles; and
(B) a SiOC coating layer containing at least Si (silicon), O (oxygen), and C (carbon) as constituent elements,
wherein the at least one silicon-based fine particles are covered with the SiOC coating layer, and
the average particle size based on a volume-based particle size distribution is in a range of 1 nm to 999 μm.

2. The SiOC structure according to claim 1,
wherein the average particle size based on a volume-based particle size distribution is in a range of 1 μm to 10 μm.

3. The SiOC structure according to claim 1,
wherein the at least one silicon-based fine particles are completely covered with the SiOC coating layer and thus a plurality of secondary particles are formed.

4. A negative electrode composition, comprising
the SiOC structure according to claim 1 as a negative electrode active material.

5. A negative electrode comprising the negative electrode composition according to claim 4.

6. A lithium ion secondary battery, comprising
at least one of the negative electrode according to claim 5.

7. A silicon-based fine particle/silicon-containing polymer composite, comprising:
(A) at least one silicon-based fine particles; and
(B) a coating layer containing a silicon-containing polymer,
wherein the at least one silicon-based fine particles are covered with the coating layer, and
the average particle size based on a volume-based particle size distribution is in a range of 1 nm to 999 μm.

8. The silicon-based fine particle/silicon-containing polymer composite according to claim 7,
wherein the silicon-containing polymer is a polysilsesquioxane.

9. The silicon-based fine particle/silicon-containing polymer composite according to claim 7,
wherein the silicon-containing polymer comprises at least one selected from the group consisting of polysilsesquioxanes having polysilsesquioxane structures represented by the following General Formulae (I), (II), (III), and (IV): 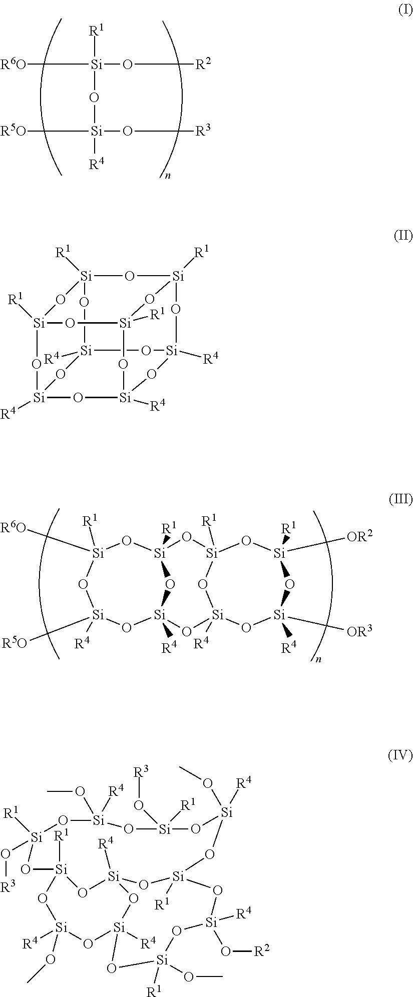
(in the formula, R¹ and R⁴ are each independently selected from the group consisting of a substituted or unsubstituted alkyl group having 1 to 45 carbon atoms, a substituted or unsubstituted aryl group, and a substituted or unsubstituted arylalkyl group, and in the alkyl group having 1 to 45 carbon atoms, any hydrogen atom is optionally substituted with a halogen atom, any —CH₂— is optionally substituted with —O—, —CH═CH—, a cycloalkylene group or a cycloalkenylene group, and in an alkylene group in the substituted or unsubstituted arylalkyl group, any hydrogen atom is optionally substituted with a halogen atom, and any —CH₂— is optionally substituted with —O—, —CH═CH— or a cycloalkylene group, and
R², R³, R⁵ and R⁶ are each independently selected from the group consisting of a hydrogen atom, a substituted or unsubstituted alkyl group having 1 to 45 carbon atoms, a substituted or unsubstituted aryl group, and a substituted or unsubstituted arylalkyl group, and in the alkyl group having 1 to 45 carbon atoms, any hydrogen atom is optionally substituted with a halogen atom, any —CH₂— is optionally substituted with —O—, —CH═CH—, a cycloalkylene group, a cycloalkenylene group or —SiR¹₂—, and in an alkylene group in the substituted or unsubstituted arylalkyl group, any hydrogen atom is optionally substituted with a halogen atom, any —CH₂— is optionally substituted with —O—, —CH═CH—, a cycloalkylene group, a cycloalkenylene group or —SiR¹₂—, and n represents an integer of 1 or more).

10. A method of producing a silicon-based fine particle/silicon-containing polymer composite, comprising
(p) producing the silicon-based fine particle/silicon-containing polymer composite according to claim 7 by hydrolyzing a silane compound represented by General Formula (V) and then performing polycondensation in the presence of a dispersant and silicon-based fine particles:
R¹ₙSiX¹₄₋ₙ (V)
(in the formula, R¹ represents a hydrogen atom, a hydroxyl group, or a substituted or unsubstituted hydrocarbon group having 1 to 45 carbon atoms, and in the hydrocarbon group having 1 to 45 carbon atoms, any hydrogen atom is optionally substituted with a halogen atom, and any —CH₂— is optionally substituted with —O—, —CH═CH—, a cycloalkylene group or a cycloalkenylene group,
X¹ represents a halogen atom or an alkyloxy having 1 to 6 carbon atoms or an acetoxy group,
when there are a plurality of R¹'s and X¹'s, they are independent from each other, and
n represents an integer of 0 to 3).

11. The method according to claim 10, further comprising the following step (p′) before Step (p),
(p′) providing a silicon-based fine particle dispersion solution containing the silicon-based fine particles, the dispersant, an acid catalyst, and a solvent,
wherein, in Step (p),
(p-1) the silane compound is added to the silicon-based fine particle dispersion solution and thus the silane compound is hydrolyzed, and
(p-2) a basic catalyst or a solution thereof is added to a reaction solution obtained in Step (p-1), a hydrolysate of the silane compound is polycondensed, and thus the silicon-based fine particle/silicon-containing polymer composite is produced.

12. The method according to claim 11,
wherein, in Step (p-1), under conditions in which the pH of the reaction solution is in a range of 2.0 to 6.0, the silane compound is hydrolyzed, and
in Step (p-2), a basic catalyst or a solution thereof is gradually added to the reaction solution obtained in Step (p-1), and thus the pH of the reaction solution is raised to a value in a range of 7.0 to 13.5, and a hydrolyzate of the silane compound is polycondensed.

13. The method according to claim 10, further comprising
(q′) filtering and/or drying the silicon-based fine particle/silicon-containing polymer composite obtained in Step (p).

14. A method of producing a SiOC structure, comprising
(q) performing a heat treatment on the silicon-based fine particle/silicon-containing polymer composite according to claim 7 under a non-oxidizing gas atmosphere and thus converting the composite to a SiOC structure,
wherein the SiOC structure comprises:
(A) at least one silicon-based fine particles; and
(B) a SiOC coating layer containing at least Si (silicon), O (oxygen), and C (carbon) as constituent elements,
wherein the at least one silicon-based fine particles are covered with the SiOC coating layer, and
the average particle size based on a volume-based particle size distribution is in a range of 1 nm to 999 μm.

15. The method according to claim 14, further comprising the following Step (p) before Step (q),
wherein, (p) a silane compound represented by General Formula (V) is hydrolyzed and then polycondensed in the presence of a dispersant and silicon-based fine particles, and thus a silicon-based fine particle/silicon-containing polymer composite is produced:
(p) General Formula (V):
R¹ₙSiX¹₄₋ₙ (V)
(in the formula, R¹ represents a hydrogen atom, a hydroxyl group, or a substituted or unsubstituted hydrocarbon group having 1 to 45 carbon atoms, and in the hydrocarbon group having 1 to 45 carbon atoms, any hydrogen atom is optionally substituted with a halogen atom, and any —CH₂— is optionally substituted with —O—, —CH═CH—, a cycloalkylene group or a cycloalkenylene group,
X¹ represents a halogen atom or an alkyloxy having 1 to 6 carbon atoms or an acetoxy group,
when there are a plurality of R¹'s and Xⁱ's, they are independent from each other, and
n represents an integer of 0 to 3),
wherein the silicon-based fine particle/silicon-containing polymer composite comprises:
(A) at least one silicon-based fine particles; and
(B) a coating layer containing a silicon-containing polymer,
wherein the at least one silicon-based fine particles are covered with the coating layer, and
the average particle size based on a volume-based particle size distribution is in a range of 1 nm to 999 μm.

16. The method according to claim 15,
wherein the dispersant is polysorbate 80.

17. The method according to claim 15, further comprising the following Step (p′) before Step (p),
(p′) providing a silicon-based fine particle dispersion solution containing the silicon-based fine particles, the dispersant, an acid catalyst, and a solvent,
wherein, in Step (p),
(p-1) the silane compound is added to the silicon-based fine particle dispersion solution and the silane compound is hydrolyzed, and
(p-2) a basic catalyst or a solution thereof is added to the reaction solution obtained in Step (p-1), a hydrolyzate of the silane compound is polycondensed, and thereby the silicon-based fine particle/silicon-containing polymer composite is produced.

18. The method according to claim 17,
wherein, in Step (p-1), the silane compound is added to the silicon-based fine particle dispersion solution by dropwise addition, and the silane compound is hydrolyzed, and
in Step (p-2), a basic catalyst solution is added to the reaction solution obtained in Step (p-1) by dropwise addition, a hydrolyzate of the silane compound is polycondensed, and thereby the silicon-based fine particle/silicon-containing polymer composite is produced.

19. The method according to claim 15,
wherein the silane compound represented by General Formula (V) comprises at least one silane compound selected from the group consisting of methyltrimethoxysilane and phenyltrimethoxysilane.

20. A method of producing a negative electrode composition, comprising
obtaining a negative electrode composition using the SiOC structure according to claim 1 as a negative electrode active material.
